(19) United States
(12) Patent Application Publication
(10) Pub. No.: US 2007/0250384 A1
(43) Pub. Date: Oct. 25, 2007

(54) Multi-purpose electronic kiosk

(76) Inventors: Glenn Earle Geller, Las Vegas, NV (US); Michael Joseph Crook, Las Vegas, NV (US)

Correspondence Address: HAYNES BEFFEL & WOLFELD LLP, P O BOX 366, HALF MOON BAY, CA, 94019, US

(21) Appl. No.: 11/409,489

(22) Filed: Apr. 21, 2006

(51) Int. Cl. G06Q 30/00

(52) U.S. Cl. 705/14

(57) ABSTRACT

The present invention relates to interactive kiosks. In particular, it relates to utility kiosks that support a variety of services, to wagering kiosks that must conform to regulatory requirements, and gaming kiosks that qualify as Class 2 or lower gaming devices, not Class 3 gaming devices.

### BACKGROUND OF THE INVENTION

The present invention relates to interactive kiosks. In particular, it relates to utility kiosks that support a variety of services, to wagering kiosks that must conform to regulatory requirements, and gaming kiosks that qualify as Class 2 or lower gaming devices, not Class 3 gaming devices.

Interactive kiosks have long been hampered by low speed or disrupted communications. Their design reflects a paucity of bandwidth.

Many gambling kiosks are restricted to the floor of establishments licensed to operate them as Class 3 gaming devices. These kiosks are most awkward to update, given the complex regulations that apply to Class 3 gaming devices.

An opportunity arises to present a new design for interactive kiosks and methods that are part of the design. Better, more easily configured and controlled, more readily updateable kiosks and kiosk systems may result.

### SUMMARY OF THE INVENTION

The present invention relates to interactive kiosks. In particular, it relates to utility kiosks that support a variety of services, to wagering kiosks that must conform to regulatory requirements, and gaming kiosks that qualify as Class 2 or lower gaming devices, not Class 3 gaming devices. Particular aspects of the present invention are described in the claims, specification and drawings.

### BRIEF DESCRIPTION OF THE DRAWINGS

FIG. 1 illustrates a first general environment in which the embodiments described are useful.

FIG. 2 illustrates a second book making environment in which the embodiments described are useful.

FIG. 3 illustrates a third gaming environment in which the embodiments described are useful. Either games of chance or games of skill fit this environment.

FIG. 4 is a block diagram that provides additional detail regarding intermediate server(s).

FIG. 5 is a high level block diagram of a terminal display.

### DETAILED DESCRIPTION

The following detailed description is made with reference to the figures. Preferred embodiments are described to illustrate the present invention, not to limit its scope, which is defined by the claims. Those of ordinary skill in the art will recognize a variety of equivalent variations on the description that follows.

At least three environments are anticipated in which the methods and devices disclosed herein are particularly useful. One environment is a utility kiosk that supports one or more of bill payment, long-distance telephone calls and Internet access, the Internet access including e-mail, directions, games and quick links to interest areas such as travel, sports, weather, movies, stocks, music, news, dining, shopping and government. Another environment is wagering, such as race and sport wagering. A third environment is gambling games of chance and games of skill.

The utility kiosk may be configured in a sturdy, tamperproof cabinet with a touchscreen, and one or more of a bill reader, card reader, barcode scanner, check scanner, telephone handset and receipt printer. A bill reader accepts, verifies and registers currency. A card reader reads a magnetic strip or, in the case of a smart card, communicates with the chip onboard the card. A barcode scanner reads a printed barcode, such as a barcode included on a payment stub of a bill. A check scanner reads and parses account number information to assist the user in correctly identifying their checking account. A telephone handset supports making voiceover IP telephone calls, both to kiosk customer service and to friends or relatives. A receipt printer is the user instructions or a record of the transaction.

In addition to the capabilities of the utility kiosk that are discussed below, the stored value card capabilities described in the related application that is incorporated by reference also apply. A stored value card may be read using the card reader or a plastic account number may be entered using the touchscreen.

Wagering and gambling kiosks may include fewer input devices that a utility kiosk. For instance, a barcode scanner is less likely be useful at a wagering or gambling kiosks that a utility kiosk. Differences among the kiosk configurations and requirements of a closed loop network that apply in some states where wagering and gambling kiosks may be used are mentioned below.

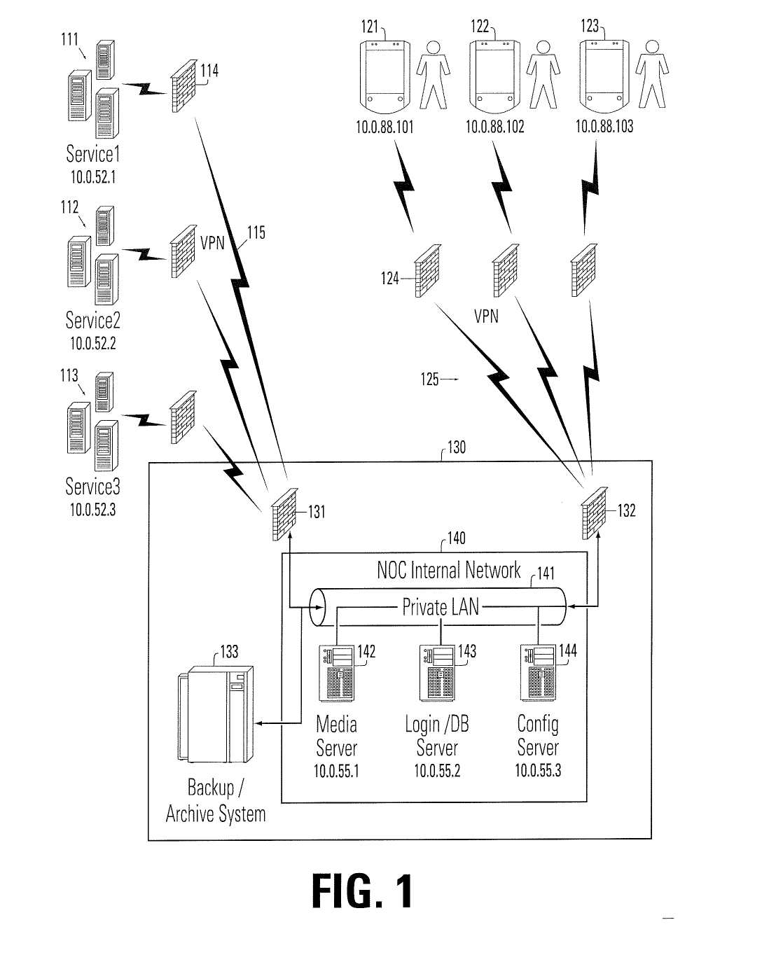

FIG. 1 is a simplified physical diagram of a network to which utility kiosk are attached. Network operating components 130 may include firewalls 131, 132, backup and archival systems 133, and a network operating center 140. A plurality of kiosks 121-123, preferably numerous kiosks, communicate through firewall and VPN hardware 124 via a VPN 125 with a VPN concentrator 132 associated with the network operating center. One or more services 111-113, either co-located or external to the network operating center, communicate through firewall and VPN hardware 114 via a VPN 115 with a VPN concentrator 131 associated with the network operating center. The network operating center 140 includes a private, internal LAN 141 which interconnects various servers. In the embodiment depicted, one or more media servers 142, logging and database servers 143 and configuration servers 144 are indicated. Addresses are assigned to the servers that are by convention non-routable. That is, standard routing devices will recognize the assigned IP addresses as internal to the network and not routable outside the private LAN. Two IP address ranges that are non-routable are 10.0.xxx.xxx and 192.168.xxx.xxx.

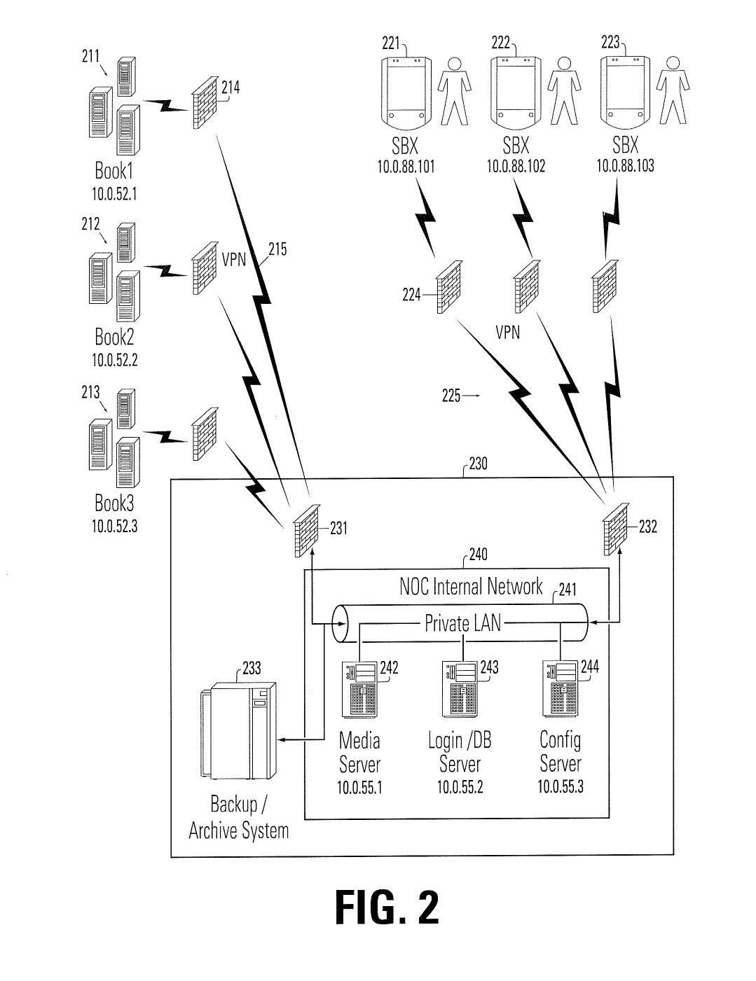

FIG. 2 is a simplified physical diagram of a network to which wagering terminals are attached, which resembles and is numbered in parallel with FIG. 1. State gambling authorities currently require, following laws originally addressed to telephone wagering, that gambling communication packets carried on the VPNs 215, 225 remain within the state's political boundaries and not cross into interstate commerce. Accordingly, the VPNs supporting wagering and gaming terminals should be connected to closed loop networks. A closed loop network maintains control over routing of packets. One example of a network that can be configured as a closed loop network and restrict the path traversed by gambling communication packets is a cable network. A local cable network may be configured with devices at non-routable addresses. Non-routable addresses also may be assigned to nodes attached to the local cable network. Packets addressed from one non-routable address to another stay on the local cable network and will not be bridged or routed by properly operating network devices to the general Internet. Packets remain within a closed loop network as they are transported between waging or gaming kiosks (collectively gambling kiosks) and books' servers or game servers. Local cable providers can configure their cable networks as intrastate networks, so that packets stay within the political boundaries of the state as long as they originate with and are addressed to non-routable IP addresses. This is much different from the typical configuration of a network provided by a regional telephone company, which applies economies of scale to operations spanning several states. Even a DNS query on a regional telephone network may be routed to or through another state.

Use of a closed loop network is different than use of a private network. A closed loop network is provided by a third party and not controlled by the operator of the gambling services. A private network, on a local campus, is controlled by the campus operator. A private network bridging campuses may use a controlled link, a dedicated link, or an arbitrary link. An example of a controlled link is point-to-point wireless communications between two buildings within a line of sight. A dedicated link may be a point-to-point T-1, T3 or faster connection or a frame relay connection. An arbitrary link may be a VPN carried across the general Internet without control of or regard for whether communication packets traverse state political boundaries. The addresses assigned to nodes connected to an arbitrary link are routable IP addresses; otherwise, subscribers to the arbitrary link network would not have Internet access. Configuration of a large area network operated by a third party covering a metropolitan area with miles of connectivity to function as a closed loop network and to comply with packet intrastate routing requirements of State gambling authorities presents new opportunities.

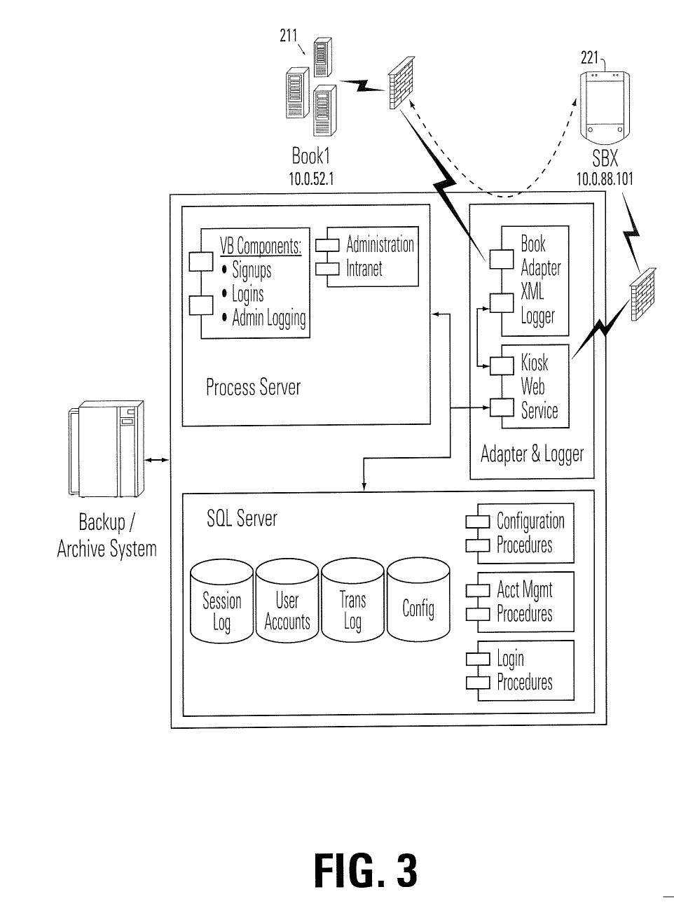

State gambling authorities also require the capability of replaying wagering and gaming sessions. FIG. 3 is a high-level block diagram that depicts one way of complying with replay requirements of State gambling authorities.

The network host 310 includes a process server 320, an adapter and logger 330 and an SQL server 340. A backup and archival system 350 is connected to various components of the network host 310. The adapter and logger 330 provide separate entry points 331, 332 for books' servers 211 and wagering kiosks 221. Adapters are written for different software systems used by books' servers, such as software systems available from PrimeLine Sports Systems and AWI. Communications between the process network 320 and kiosks 221 are in XML, to the extent practical. For instance, logging entries generated by the kiosks 221 are coded as XML messages at the kiosks. These logging entries may be generated in parallel with responses to wagering screens. Alternatively, the response to wagering screens may be sent by the kiosk in XML format and translated into an ASP-compatible format by the adapter 331 and forwarded to the wagering server 211 through firewalls such as 214. HTML screens posted by a books' server to an ASP server and adapter 331. Screens conform to a message standard block standard and/or are registered with the network host, to permit the adapter 331 to verify the screens and log them in a convenient format. Screens from the wagering server may be forwarded directly to the wagering kiosks or encapsulated with XML tags to define the beginning and end of a particular wagering screen, then forwarded to the wagering kiosks.

An alternative embodiment will accept XML messages from the books' servers 221 and log the XML messages, instead of translating ASP into XML for logging. XML messages will be combined with style sheets, such as XSLT style sheets, for display.

The administration intranet 322 provides an ASP interface to the kiosk Web services that supports recall of logged wagering sessions. Sessions that originated from the book's server as ASP pages can be replayed as ASP pages.

Native Visual Basic (VB) components 321 handle administrative access, such as signup, logins for administrative purposes and reconfiguration of kiosks.

The SQL server 340 handles kiosk-related services. Its database provides initial configuration services 344, session logging 341, user accounting 342 and transaction logging 343. Logs of wagering or gaming activity can be maintained on the backup/archival system 350, by the SQL server 340 or both. Stored procedures are kept on the SQL server to support kiosk configuration at startup 345, account management 346 and logins 347.

In a kiosk session, the customer who wants to place a wager first logs into the network host 310. The process server 320 and SQL server 340 handle the customer's initial login and then present the customer the opportunity to select a book's wagering service. Until a wagering session begins between the customer and the book's server, the process server 320 uses XML messages to communicate with the kiosk 221.

The wagering server 211 has its own login protocol. The wagering server 211 delivers screens for the kiosk 221 by posting them to an ASP page on the adapter 331. (ASP is a Microsoft language that supports server-side scripting, which reduces the communication and browser processing requirements.) The adapter fits in between the book's server 211 and the kiosk 221 in much the fashion of a proxy server, to support logging. Looking at the details of a book's server, PrimeLine's wagering server is a Java-based JBOS web server with JavaScript integration. The process server does not care about the internal programming of a wagering server, except to be able to recognize and verify the screens generated by the wagering server for the kiosks. A Tomcat server using static HTML, a dynamic HTML server, a Java application or Flash application could be generated by the wagering server, with an appropriate adapter 331 to convert displays into an easily logged format.

During a wagering session, a modified browser running on the kiosk generates both direct wagering messages bound for the wagering server 211 and XML-based log messages directed to a logging server associated with the adapter and logger 330. Separate sockets or network ports are open on the kiosk to transport the wagering messages and the XML log messages to their distinct destinations. A modified browser is used so that a publishable standard for logging can be adopted. This supports expansion of the kiosk network to a variety of wagering servers and non-wagering services. The prototype wagering interface uses an adapter to support the legacy PrimeLine wagering system within a scalable architecture. XML formatted logging messages are useful because the end of a message is distinctly marked, according to XML conventions. When a particular XML message type is received, it complies with a message type definition. The process server components can test the message received, be assured of the message integrity and report that logging has been successful, if desired. A bit-stream, in contrast, is less well-defined semantically and much more difficult to parse.

A logging discipline requires compliance with a message block standard and/or registration of screens generated by the booker's server. If screens and logging information received from the booker's server do not match the message block standard or one of the pre-registered screens, the process server will lock the communication channel and refuse to proceed in a wagering session. In this way, unanticipated wagering activity is blocked.

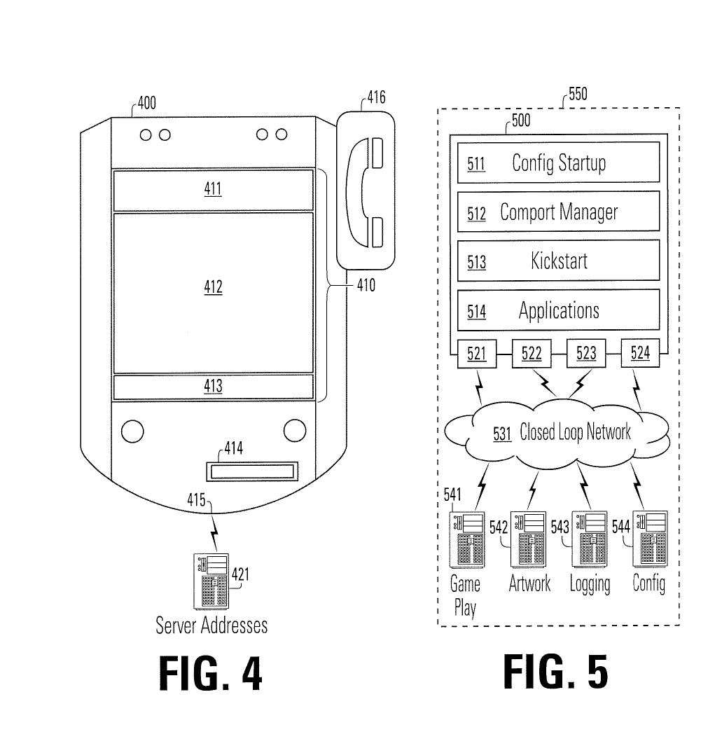

FIG. 4 is a block diagram of a kiosk 400. It includes a screen 410 with at least one touch sensitive area. In one embodiment, the screen is partitioned into an advertising area 411, a user interactive area 412 (at least part of which the book's server 221 controls) and a status display 413. In one embodiment, the user interactive area is divided between an area for displays from the book's server and a touch screen keyboard for input. A card reader 414 is depicted and one or more network ports 415, through which the system may obtain configuration data from a configuration server 421. The card reader may recognize a magnetic strip, electrical contacts (e.g., of a smart card), RFID signals or magnetic encoding within the card. Other devices that may be built into a kiosk include a currency reader, a check encoding reader, a bar code scanner, a voice over IP telephone handset and a printer.

In one approach to startup, a boot code running on the kiosk 400 opens a database network port and establishes a database session with a configuration server 421. It requests configuration data, for instance by sending an SQL query with the kiosk's unique ID. The configuration server provides data for a variety of parameters, including one or more of: partitioning of the kiosk display into at least areas for advertising, interactive display and session status; addresses of servers other than the SQL server, including ports, for instance servers for downloading user interaction programs and input device interfaces, advertising media, proxy communications with a wagering server, communications with a gaming server for game artwork and game play tokens, and gambling session logging. The configuration server may provide additional configuration data in support of stored value card services that are described in the related application that is incorporated by reference.

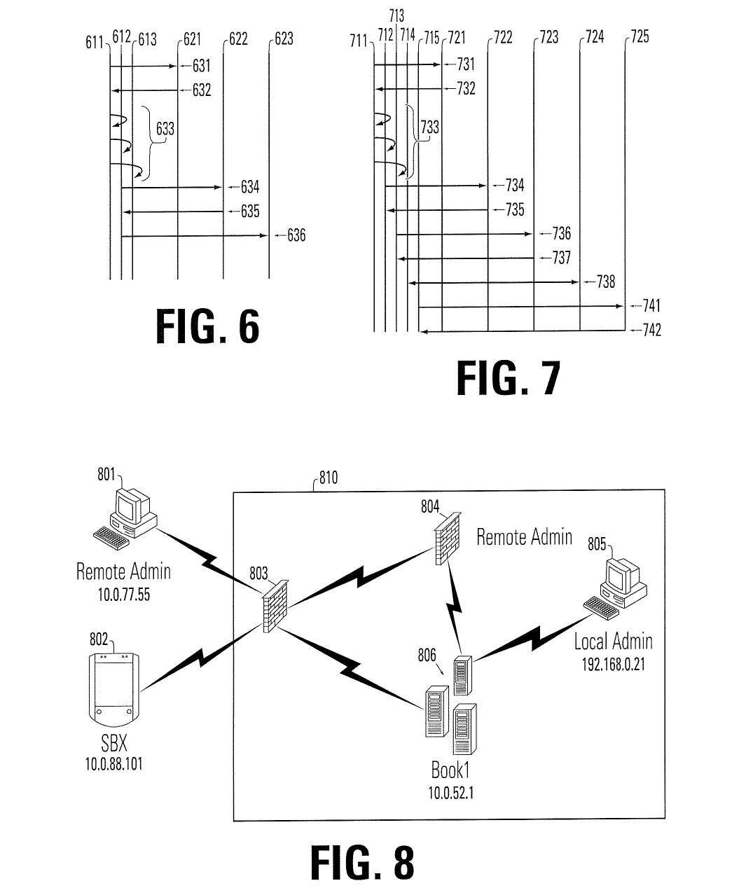

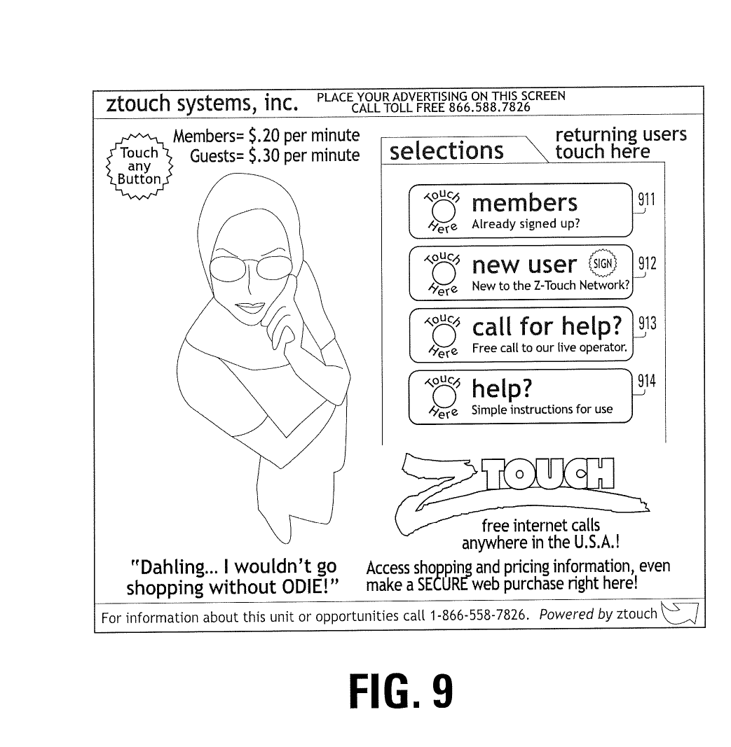

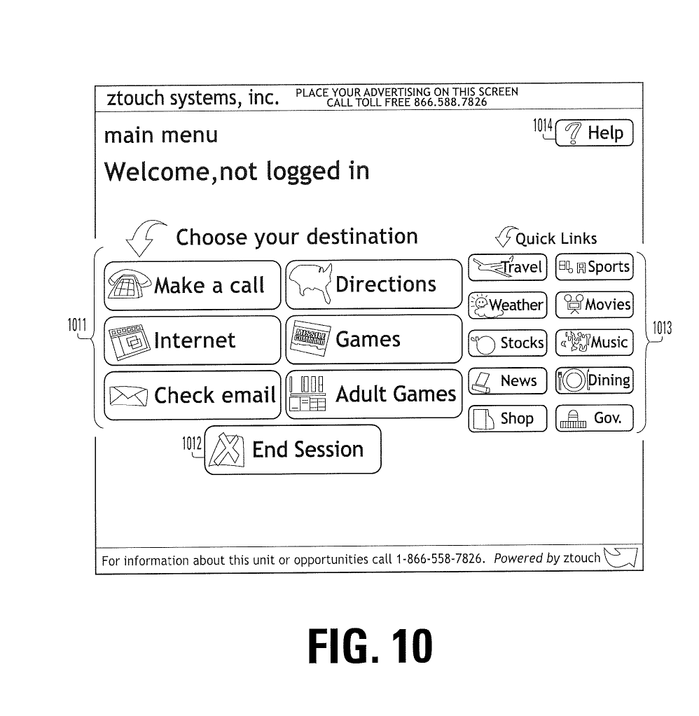

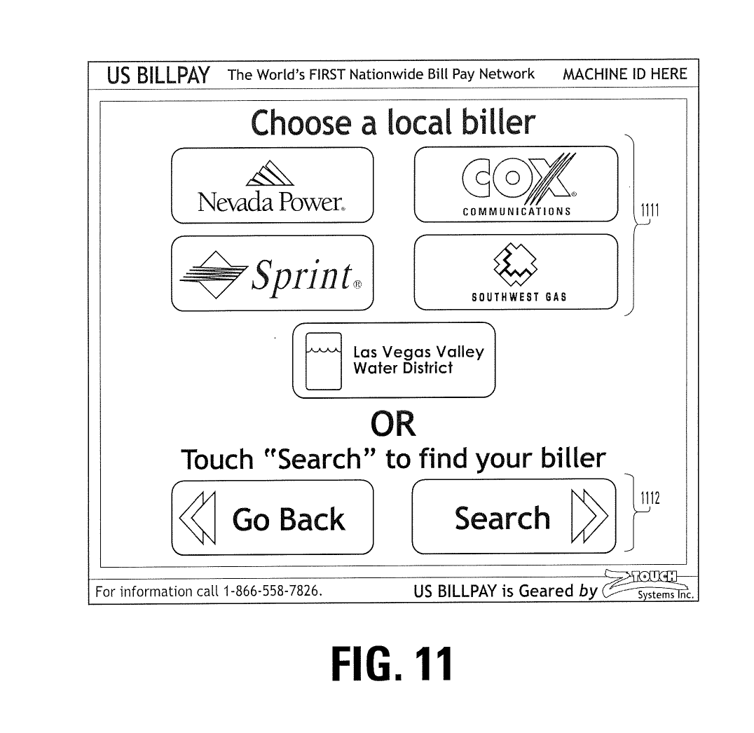

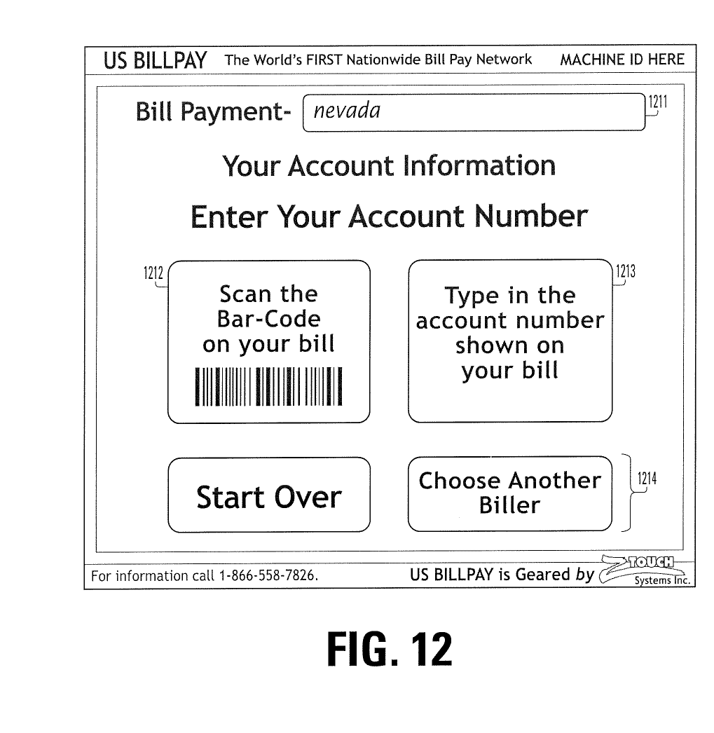

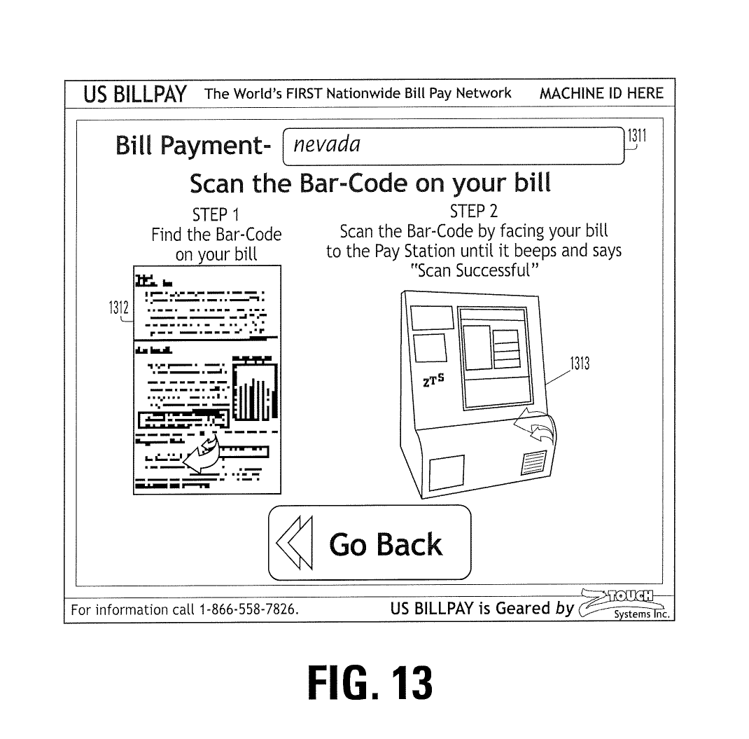

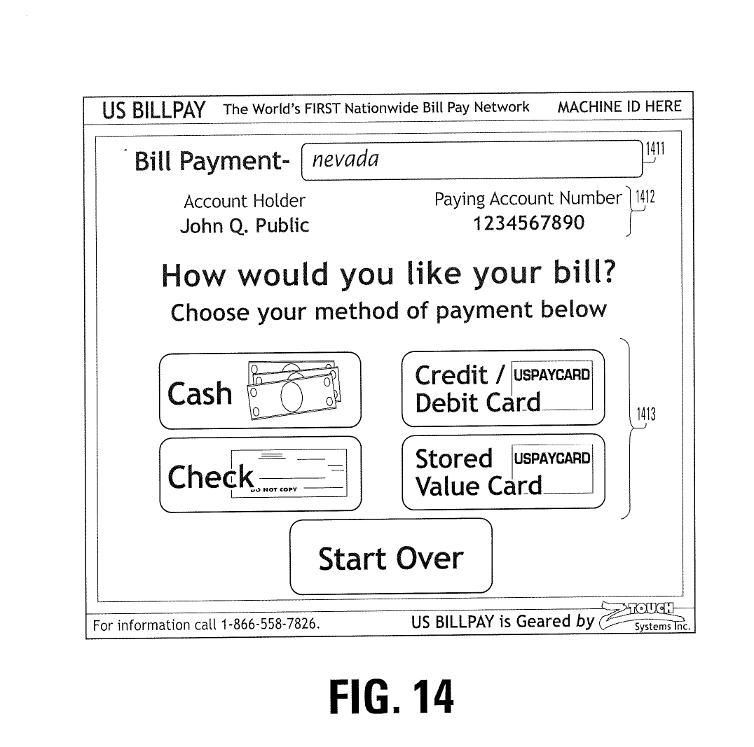

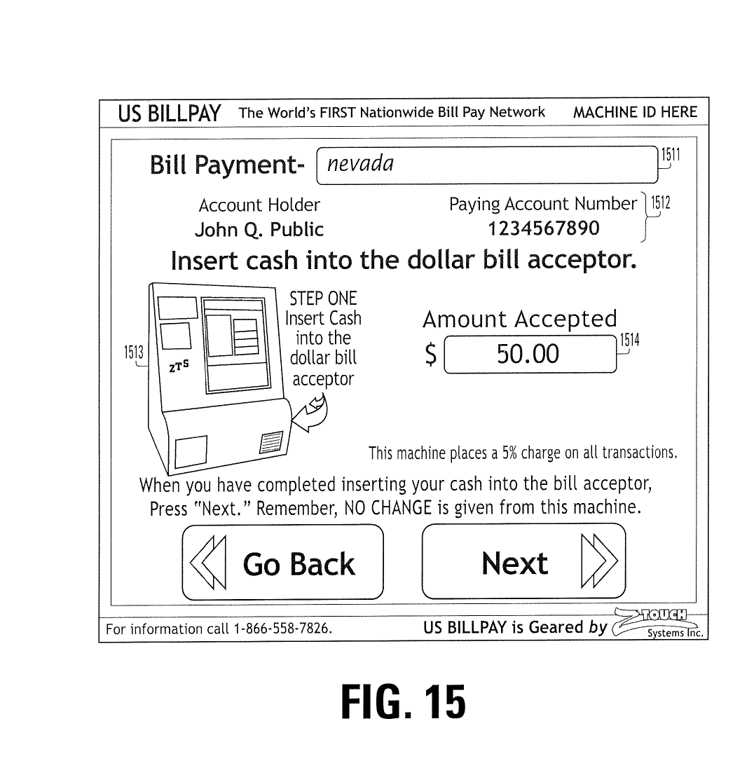

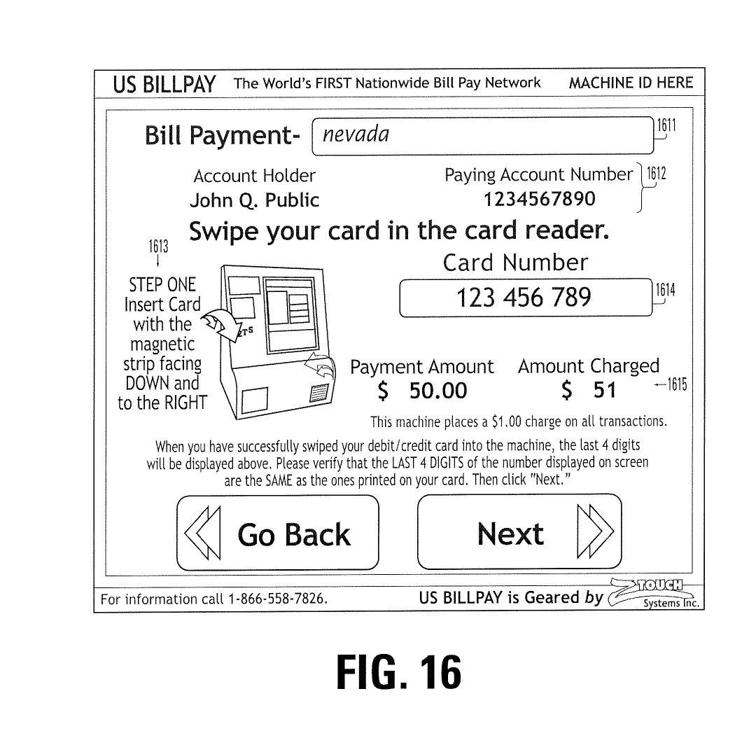

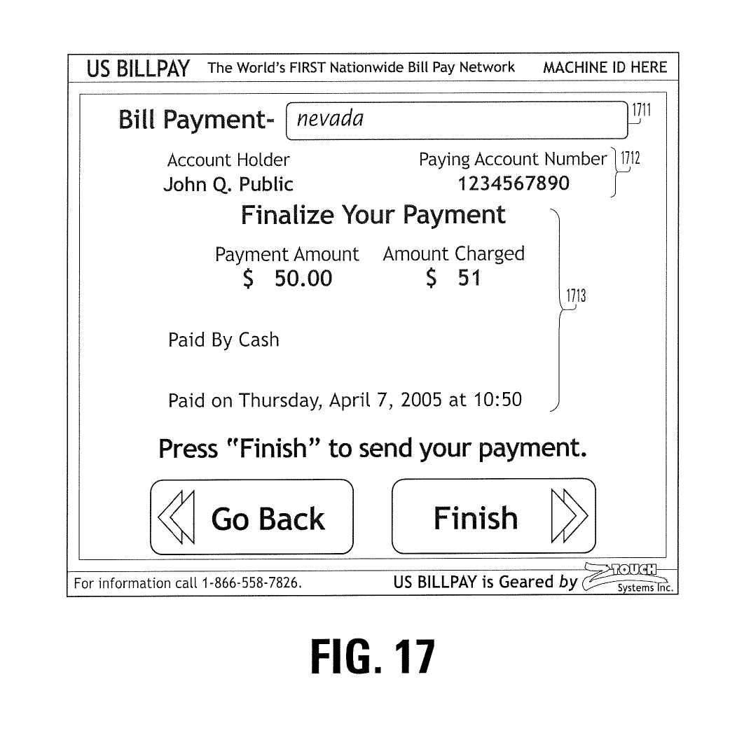

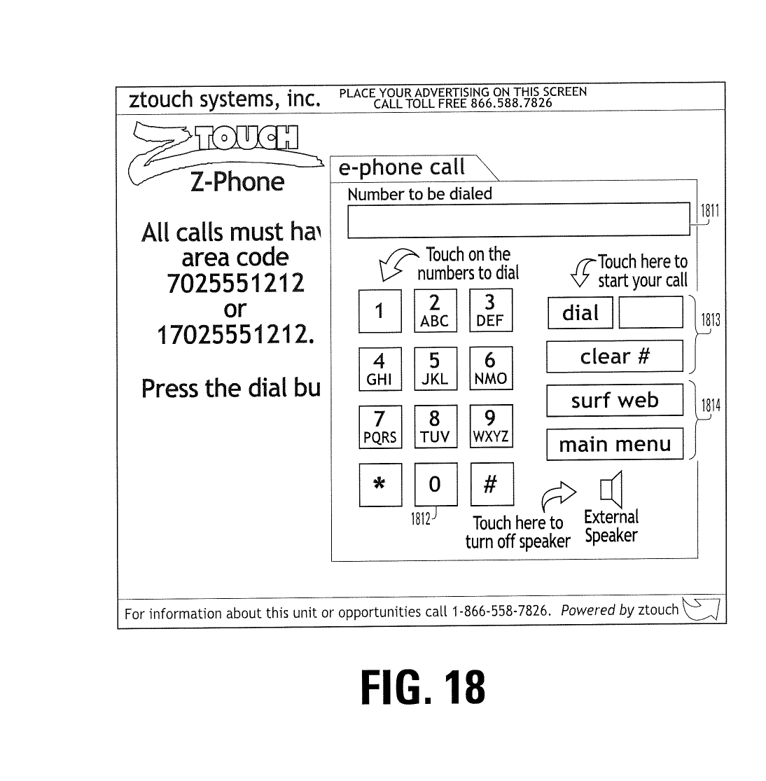

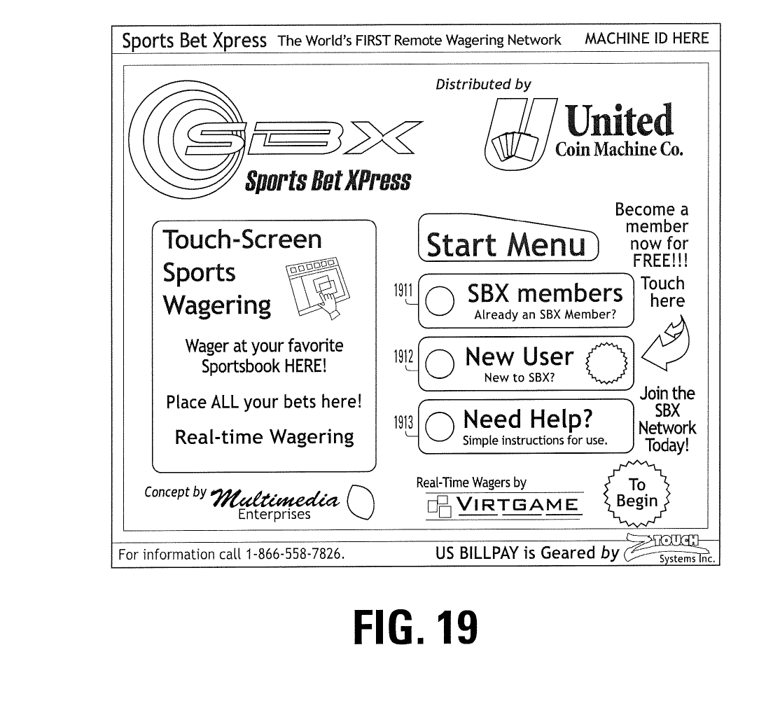

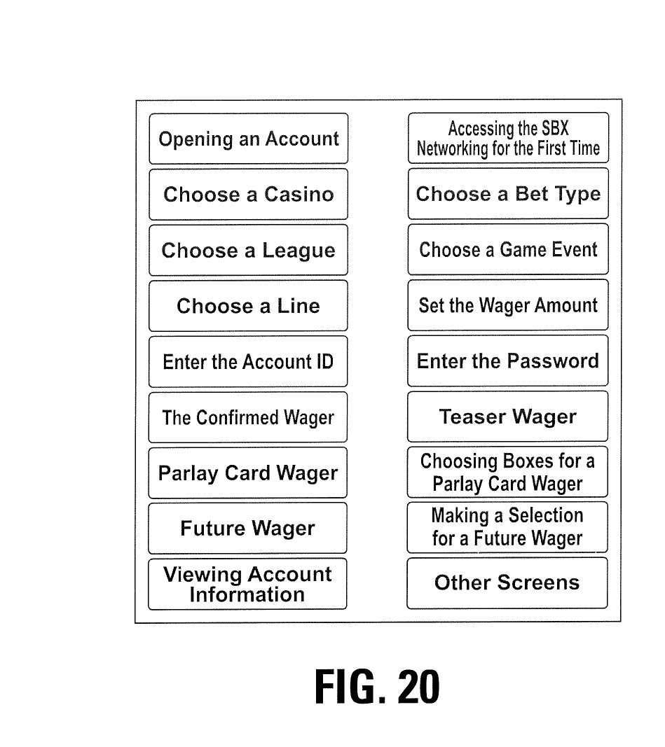

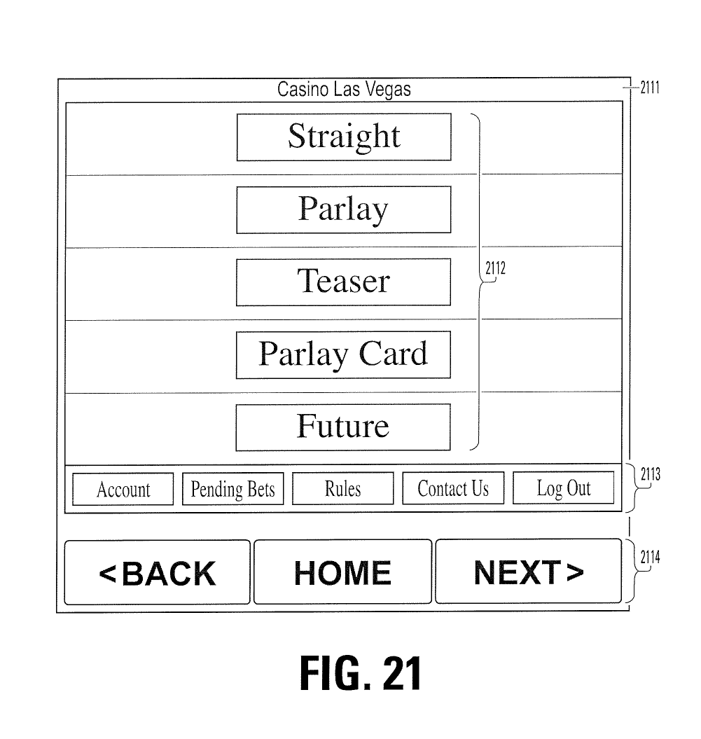

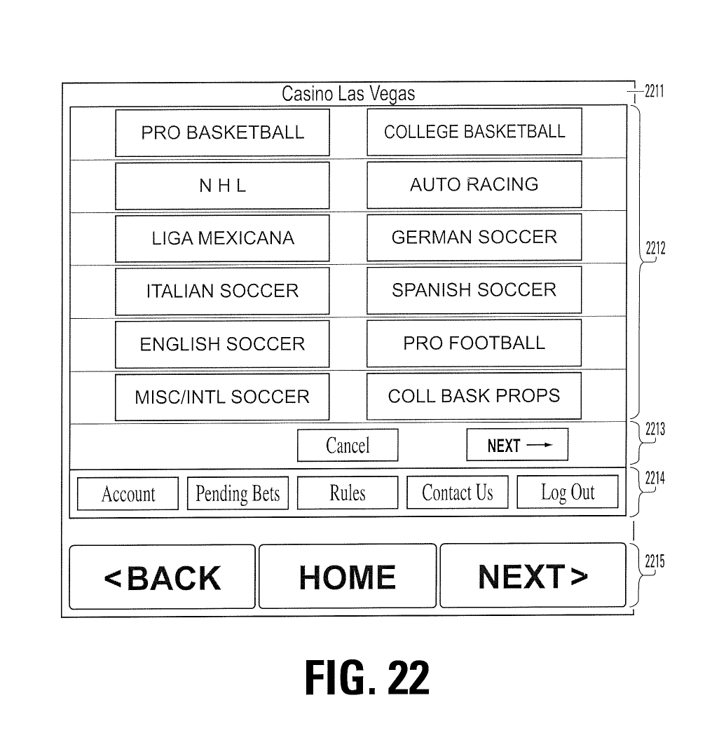

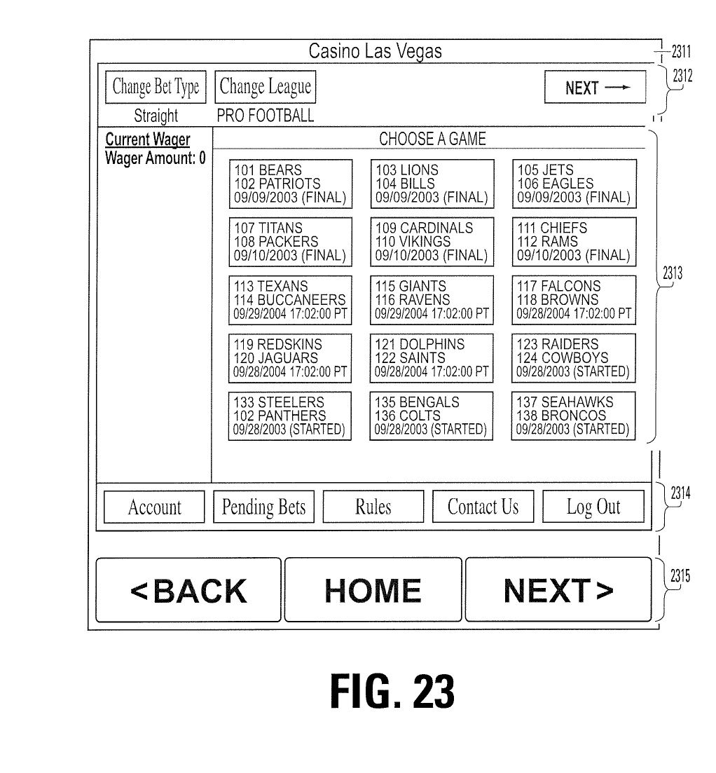

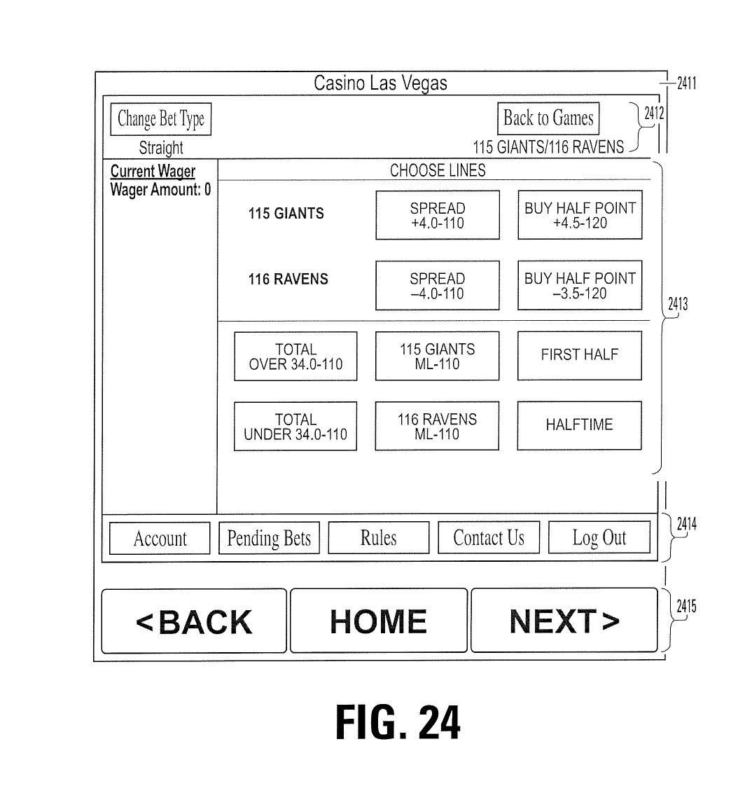

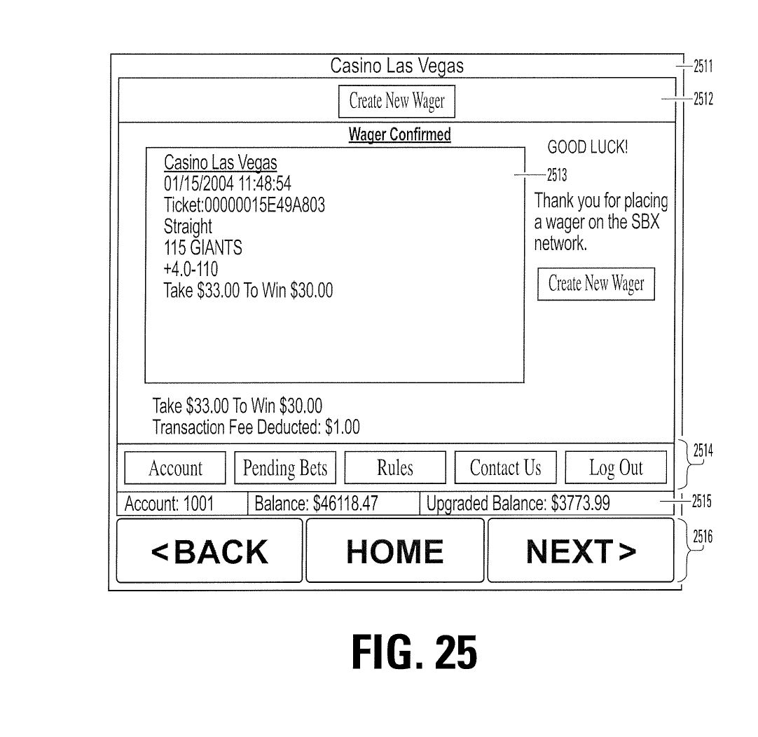

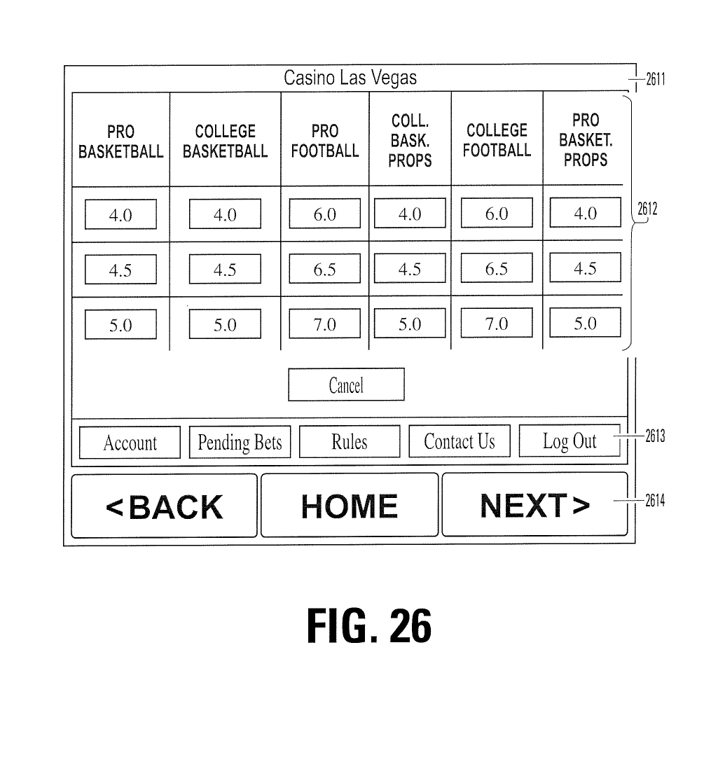

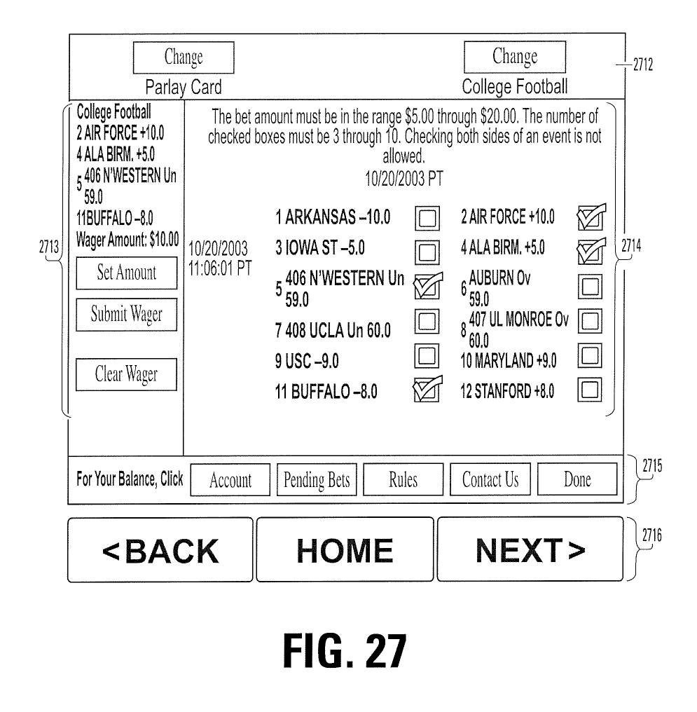

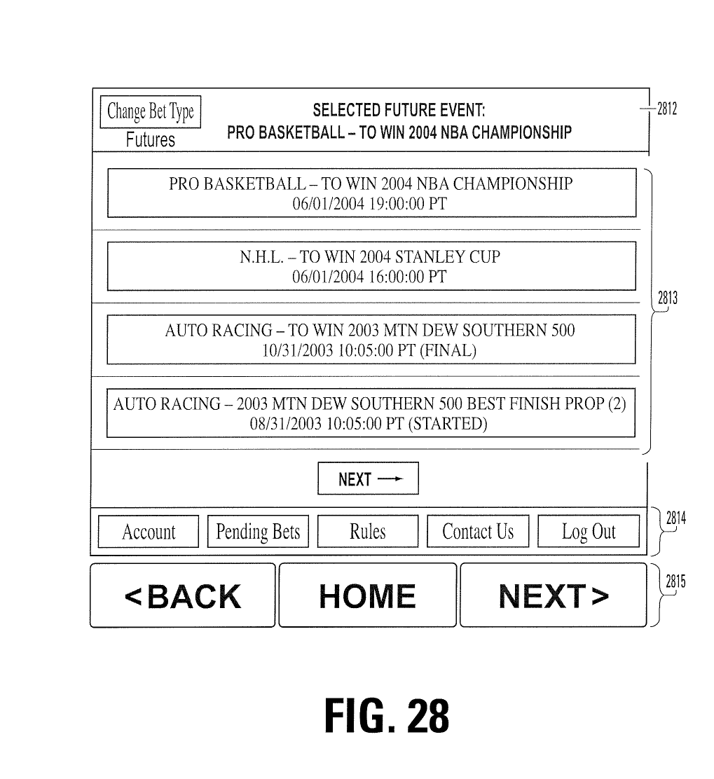

FIG. 5 is a high-level block diagram of software and server components that may be combined in a system including a kiosk 500. The kiosk may include a configuration startup routine 511, e.g., as part of a boot code, a comport manager 512 that interface the kiosk with devices such as a card reader, a currency reader, a check encoding reader, a bar code scanner, a voice over IP telephone handset and a printer. The comport manager code may be downloaded during configuration or may reside in non-volatile memory of the kiosk. A kickstart application 513 starts, kills and restarts applications 514 and components of the comport manager 512. The kickstart application monitors the health of other software components and restarts them as necessary. The kiosk supports a plurality of logical network ports 521-524, which may utilize one or more physical channels. Communication packets exchanged with servers 541-544 are carried by a network. As explained above, a closed loop network 531 may be necessary to satisfy State gaming authorities. Using a closed loop network, the communication packets remain within the political boundaries of a State 550 and are not launched into interstate commerce.

The servers 541-544 are depicted as separating game play tokens 541 from artwork delivery 542. Game play tokens are typically generated from the results of running a random number generator. While one random number generator can be used across multiple gaming sessions, it is preferred to instantiate a random number generator for each gaming session. In this sense, a gaming session may involve a single kiosk or related kiosks that are participating in the same game of chance or game of skill. Separate random number generators result in allocation of favorable events within a session, instead of allowing a favorable event in one session to deprive players in another session of a chance at the favorable event. Separate random number generators also may be easier to scale to handle increasing traffic.

The game play server 541 is designed to hold game play tokens that reveal the next event that impacts the outcome of a game until after gamers have place their bets and selected their game play actions. After a kiosk and related kiosks participating in a particular game session have delivered their game play tokens for a particular move or round of play, the game play server 541 distributes the next game play tokens to the kiosks. If the game play tokens were delivered earlier, there would be two consequences. First, the game play tokens would be subject to interception when transported and subject to probing once delivered. This would make the games vulnerable to manipulation. Second, the kiosks could become Class 3 gaming devices, which are subject to a higher level of regulatory scrutiny and control. The kiosks are easier to defend physically and to have approved by gaming agencies when random events are all determined at a remote gaming server and game play tokens are delivered only after bets and game play actions are received by the gaming server.

FIGS. 6-7 depict use of multiple ports by the kiosk to separate traffic elements. The figures are numbered in parallel. A plurality of sockets or network ports is illustrated, 611-613 and 711-715. These ports may handle traffic to an SQL server, a wagering server proxy and a logging service. Alternatively, a larger number of ports may handle traffic to an SQL server, a gaming server artwork service, a gaming server game play token service, VOIP to customer service and a logging service. Additional network ports may be dedicated to downloading user interaction programs and input device interfaces and to downloading advertising media. Priorities may be assigned among the ports, for instance to accelerate game play by giving high priority to game tokens or to improve the quality of voice communications by giving high priority to VOIP packets.

In sequence, a database port 611, 711 is opened and a query 631, 731 sent to a configuration server 621, 721. This may be an SQL query using a unique kiosk ID as a key. Configuration data 632 is returned. The kiosk configures itself 633, including opening additional network ports 612-613, 712-715. In a wagering situation, screens and user responses are communicated 634, 635 through a book's server proxy 622 on a proxy port 612. Logging messages 636 are concurrently sent to a logging serve 623 by a customized browser running on the kiosk.

In a gaming situation, more ports 711-715 are likely to be used. After configuration 733, the kiosk uses a port 712 to request and download 734, 735 interaction programs and/or screens from a server 732. When the user selects a game 736, another port 713 is used to download the game interaction components and/or artwork 736. If the user needs help, a VOIP port is opened 714 to customer service 724 for a support call 738. During game play, another port 715 connects the kiosk with a game play server 725 and game play tokens are exchanged 741, 742. In one embodiment, game play is conducted in the same format as it is logged, so there is no need for a separate logging port or separate logging messages. It is anticipated that the gaming situation will cover both games of chance and games of skill.

In case of gaming session disruption, logging may include the state of the random number generator, so that replay can actually restart the game. This may be possible for random number generators that behave consistently, once seeded.

FIG. 8 depicts a feature for controlling remote access to a gaming or host facility. Persons outside the facility 810 may be users 802 or administrators 801. In this embodiment, both types of users send their packets through the first firewall 803. The first firewall routes user packets to a first network interface of the server 806 and routes administrative packets to a second firewall 804. The second firewall routes administrative packets to a second network interface of the server 806, which is the same interface used for local administration 805. In this embodiment, remote administration is disabled by physically disrupting communication of administrative packets through the second firewall 804 to the server 806. For instance, the second firewall can be powered down. Or, cable connections leading to or from the second firewall can be interrupted (e.g., unplugged.)

Portions the graphic user interface reveal additional features. FIGS. 9 through 28 are selected portions the user interface for utility kiosk, particularly in bill payment and e-phone call modes, and for the wagering kiosk.

FIG. 9 depicts a first screen for utility kiosk. The user indicates on a touchscreen that they are a member 911 or a new user 912 or to seek live 913 or on-screen 914 help. A returning user will enter a username and password. The new member may either identify themself with abbreviated information or full and verifiable information. Abbreviated information may be limited to name, e-mail address, ID and password. Fuller information may include the user's address and birthdate. The system may award for free minutes for signing up and/or for completing a survey.

FIG. 10 depicts capabilities of the utility kiosk. Modes of using the terminal appear as destination buttons 1011. The destinations may include making a telephone call, surfing the Internet, checking e-mail, getting directions, playing games or playing adult games, such as gambling. A member profile may permit the user to configure their e-mail, for ease of entry. The utility kiosk is a public Internet terminal designed for ease of use and to make access to the Internet a pleasant experience. The user may make a call from the utility kiosk as easily as calling from home. They simply select a phone screen and enter a phone number using the touchpad. They touch that dial button to make call and when finished touch the end button. The main menu of the utility screen can be accessed by touching the main menu button. To surf the Web, user touches the Internet button. A variety of popular web sites, potentially providing advertising revenue to the kiosk operator, may be displayed on the initial screen 1013 or when a user selects Internet surfing. A pop-up touch driven keyboard is displayed on the kiosk. Web sites are scaled to fit the display of the unit. Checking e-mail is as easy as pressing the e-mail button, followed by selection of the e-mail service that the user uses at home or work and then logging in. A directions button provides the user with the location of a business, place of worship or other address selected by the user. Games buttons are provided for youthful and adult games. The user logs off by touching the button marked end session 1012. Time used at the kiosk is deducted from the user's account and the remaining balance is updated. On-screen help is available 1014.

FIG. 11 depicts an initial screen for paying bills that the utility kiosk. The user selects the local biller 1111. The group of local billers displayed may be selected based on the geographic location of the kiosk, using the hierarchical kiosk ID described above in the discussion of advertising delivery.

FIG. 12 gives a user choices as to how to select their account. A window indicates the local biller selected 1211. Buttons allow the user to select bar-code scanning 1212 or typed entry of an account number 1213. Other buttons allow the user to choose another biller or start over 1214. If a user selects scanning a bar-code from their bill, a screen such as FIG. 13 is displayed. The local biller is again displayed 1311. Directions are given for finding a bar-code on a bill 1312. These directions may be customized to the local biller that has been selected, so that the actual placement of a bar-code on a sample bill is displayed. A picture of the utility kiosk 1313 is marked to direct the user to the scanning device built into the kiosk.

FIG. 14 is a screen that allows the user to select a payment method. The local biller is identified in a window 1411. Account information obtained either by scanning a bill or entry by the user is displayed 1412. The user is given choices which may include depositing cash, making a direct withdrawal from a checking account, or using a credit or debit card for using a stored value card 1413. The screens that follow depend on the method of payment selected.

FIG. 15 is a screen for payment with cash. The local biller is identified in a window 1511. Account information is again displayed 1512. A picture of the utility kiosk 1513 is marked to direct the user to the bill or currency acceptor. After bills are accepted, the amount accepted is displayed 1514. A message may be displayed to indicate the charge levied for using the kiosk. Some models of the kiosk will be unable to provide any change, so the user is reminded of this limitation.

FIG. 16 is a screen for payment using a card reader. The local biller is identified in a window 1611. Account information is displayed 1612. A picture of the utility kiosk 1613 is marked to direct the user to the card reader. When the card has been inserted and successfully read by the reader, a card number and/or cardholder's name is displayed 1614. After a payment amount has been selected, the payment amount and total charge may be displayed 1615. In addition to the card swipe, user may be asked to enter a printed security code located elsewhere on the card or to enter the billing zip code for the card. For some cards, the user is asked to enter a PIN.

FIG. 17 is a confirmation screen. The local biller is identified in a window 1711. Account information is displayed 1712. The payment amount and total charge are again displayed 1713. The user may select to go back or complete the payment.

FIG. 18 is a telephone call touchscreen. As described above, the screen provides a keypad 1812 for entering members, including area code. As numbers are entered, they appear in a window 1811. The call is controlled by dial, end, and clear number buttons 1813. The user can navigate to another system feature by selecting a surf web or main menu button 1814. Optionally, an external speaker may supplement use of the handset at the kiosk.

FIG. 19 depicts how the kiosk is adapted to wagering. When the user approaches a wagering kiosk, they identify themselves as a returning member 1911 or a new user 1912. On-screen help is available 1913. Initially, the user is presented a number of choices. The user may begin by joining the gaming host network as a new member. An on-screen keyboard allows them to create a username and password and to complete a member sign-up process. The user settings are stored and can be used at any wagering kiosk operated by the network host, subject to state gaming authority limitations on location. A variety of identifying information is required, such as address and birthdate. The wagering network host may require less information than the casinos, as the wagering network more closely resembles a telephone network than a betting operation. Prior to placing a wager, a user must have a valid wagering account with one or more participating casinos. That typically requires that the user visit a participating casino in person to set up an account and either deposit funds or make arrangements for settlement of bets.

In the embodiment illustrated by FIG. 20, the user's choices include opening an account, accessing the wagering network for the first time, selecting a casino or book, choosing a bet type, choosing a league, choosing a game or event, choosing a line, setting a wager amount, entering an account ID, entering a password, confirming a wager, selecting a teaser wager, selecting a parlay card wager, entering information for a parlay wager, selecting a future wager, entering information for a future wager, viewing account information or other screens. Because user IDs for the host network and the individual casinos are issued by different authorities, they are likely to differ.

The wagering network host may restrict the user's access to casino generated information to those casinos at which the user has a valid account. The casinos also may restrict the information that they provide by requiring a login. The user chooses a casino and follows the casino's login procedures. The user then chooses a bet type.

FIG. 21 depicts a user interface for selecting a bet type. The casino's name is displayed in a banner 2111. Types of bets are offered 2112. Account related options, such as account selection, pending bets, casino rules and logout are provided 2113. In addition, the user has the option of contacting the casino. General navigation buttons are provided 2114. The user touches the button for the desired action.

FIG. 22 depicts a user interface for choosing a league. The casino's name is displayed in a banner 2211. Betting activities are displayed 2212, such as professional basketball, the National Hockey League, professional football, various soccer leagues and auto racing.

Navigation buttons are provided 2213 and general navigation buttons 2215. Account related options, such as account selection, pending bets, casino rules and logout are provided 2214.

FIG. 23 depicts a user interface for choosing a game, after the league has been selected. The casino's name is displayed in a banner 2311. Navigation buttons 2312 and general navigation buttons 2315 are provided. Available games for betting our identified 2313. Account related options, such as account selection, pending bets, casino rules and logout are provided 2314.

FIG. 24 depicts a user interface for choosing a line, after the game has been selected. The casino's name is displayed in a banner 2411. Wagering-related choices are offered 2412. The user is offered the choice of teams to win, the option to buy a tie-breaking half-point, over and under bets and other variations on betting 2413. Account related options are provided 2414. Not shown are screens for setting the wagering amount, entering an account ID and entering a password. After touching the submit wager button, a wager amount screen is displayed. The user chooses from a list of common wager amounts by touching the associated button or can type in a particular wager amount using the on-screen keyboard. An OK button is touched to confirm the wager amount. Either after entering a wager amount or upon requesting account related information, the user is asked for a casino account ID, which is an account number assigned by the casino. The user enters the account ID using keyboard. They are prompted for a password and enter the appropriate password. The transaction fee applicable to making the wager from the wagering kiosk can be confirmed with the password entry or displayed with the confirmed wager. It may be preferred to display the transaction fee with the password confirmation or another confirmation screen, before the bet is finalized.

FIG. 25 depicts a wager confirmation screen, after a wager has been placed. The casino's name is displayed in a banner 2511. The option of creating the next wager is offered 2512. The wager is summarized 2513. Account related options are provided 2514. With the wager confirmation, account balance information also is provided 2515. General navigation buttons are available 2516.

FIG. 26 allows a user to choose a teaser type of bet. The user touches the button corresponding to the number of points and the league in which the teaser bet is placed. Teaser bets may be available only for football and basketball. Account information 2613 and general navigation 2614 buttons are provided.

Another type of bet is a parlay card. The user may choose a parlay card bet type and then select a kind of game in which a parlay card will be composed, such as basketball, football or college football. FIG. 27 depicts a parlay card for college football. Buttons are provided to change the bet type or the kind of game in which the parlay card is being entered. A list of games is displayed, from which the user can select, for instance, three to 10 game winners 2714. In addition to selecting the winners, the user sets a wager amount and submits the wager 2713. Account related 2715 and general navigation 2716 buttons are provided.

FIG. 28 depicts selection of a future waiver. When a user chooses a bet type of future, an interface is provided showing available futures. A button is provided to change the bet type 2812. Choices of futures 2813, such as the winner of the National Basketball Association championship, the NHL Stanley Cup, or the Mountain Dew Southern 500 auto race are offered. When the user selects a particular future, a user interface such as depicted in FIG. 28 is displayed. This shows the choices that may be combined to make a parlay card bet. The user selects one of the competing teams to win, for instance the Red Wings to win the Stanley Cup.

### Some Particular Embodiments

The present invention may be practiced as a method or device adapted to practice the method. The same method can be viewed from the perspective of the kiosk or the network to which the kiosk is attached. The invention may be an article of manufacture such as media impressed with logic to carry out computer-assisted operation of the kiosk.

One embodiment is a method providing online kiosk services, including executing a boot code on a computerized interactive kiosk attached to a network, the boot code opening a network port to a remote database and making a query to retrieve configuration data. The method further includes receiving from the remote database the configuration data and applying the configuration data to configure a variety of kiosk characteristics. Various groupings and characteristics may be useful. One group of characteristics is partitioning of the kiosk screen into at least advertising, interactive display and status areas, enabling at least one input device coupled to the kiosk, and identifying one or more server address from which the kiosk will obtain data. The data obtained may include advertising media, programs that interact with the user and programs that control the input device. The configuration data may further be used to configure screen dimensions of the kiosk screen, to configure a touchscreen input device, to configure a currency reader, a card reader, a check encoding reader, a barcode scanner or a voice over IP telephone. This method also may be practiced as a device. The device is a computer implemented kiosk, including memory, a network connection, a processor coupled to the memory of a network connection, and logic and resources coupled to the processor and adapted to carry out the method and various aspects of the method described above.

A further aspect of the method described includes applying the configuration data to enable communications with at least one book's server that provides online wagering. This method further includes opening two or more further network ports to communicate wagers between the interactive kiosk at the book's server and to log with an intermediate server game imports and terminal displays during wagering sessions. It also may include logging the wagering session with the intermediate server in real-time, as the wagering session is conducted, with sufficient detail to permit replay of the wagering session. This aspect further may include transport and communication packets between the interactive kiosk at the book's server on a closed loop network without transporting the communication packets across the political borders. Optionally, communication packets may be assigned IP addresses that are understood by routing devices to be internally affordable within the closed loop network and not externally routable outside the closed loop network. The method further may include parsing screen sent by the book's server to the interactive kiosk, verifying that the screen substantially match registers screens previously provided by the book's server and representing the screens and users responses to the screens for logging in a format with the distinctive industry marker. In this sense, an industry marker shows were a particular screen a user response can be considered complete. Again, the method may be practiced as a computer implemented kiosk, including memory, a network connection, a processor coupled to the memory of a network connection, and logic and resources coupled to the processor and adapted to carry out the method and various aspects of the method described above.

Yet another aspect of the method described includes applying the configuration data to enable communications with at least one game of chance server that provides a least one downloadable gameplay program. This method further includes opening two or more further ports to communicate artwork from the game of chance server to the interactive kiosk and to communicate gameplay tokens. This method further may include logging the gameplay session with an intermediate server in real-time, as gameplay proceeds, with sufficient detail to permit replay of the game play session. It may further include displaying the artwork on the interactive kiosk consistent with the gameplay tokens. Optionally, it may further include generating gameplay tokens with gameplay server having a random number generator that is dedicated to the interactive kiosk and any related interactive kiosk receiving the same game play tokens for a particular session game of chance. The gameplay server further may be configured to delay delivering any gameplay tokens that reveal an outcome of the gameplay until the interactive kiosk to deliver to the gameplay server gameplay tokens that define the gamers and bats and gameplay actions. As with proceeding methods, this method may be practiced by transporting communication packets on a closed loop network without transporting the communications packets across state political borders. And, the method may be practiced as a computer implemented kiosk, including memory, a network connection, a processor coupled to the memory of a network connection, and logic and resources coupled to the processor and adapted to carry out the method and various aspects of the method described above.

An additional aspect of the method described includes applying the configuration data to enable communications with at least a game of skill server that provides at least one downloadable gameplay program. This method further includes opening two or more further network ports to communicate artwork from the game of skill server to the interactive kiosk and to communicate gameplay tokens. This method further may include logging the gameplay session with an intermediate server in real-time, as gameplay proceeds, with sufficient detail to permit replay of the gameplay session. It also may include displaying the artwork on the interactive kiosk consistent with the gameplay tokens. If further may include generating gameplay tokens with the gameplay server having a random number generator that is dedicated the interactive kiosk and any related interactive kiosks receiving the game play tokens for a same session of the game of skill. The gameplay server further may be configured to delay delivering any gameplay tokens that reveal an outcome of the gameplay until the interactive kiosk to deliver to the gameplay server gameplay tokens that define the gamers and bats and gameplay actions. As with proceeding methods, this method may be practiced by transporting communication packets on a closed loop network without transporting the communications packets across state political borders. And, the method may be practiced as a computer implemented kiosk, including memory, a network connection, a processor coupled to the memory of a network connection, and logic and resources coupled to the processor and adapted to carry out the method and various aspects of the method described above.

Another embodiment is a method channeling communications related to a betting session involving at least the book's server, and an intermediate server, and an interactive kiosk, the book's server and the interactive kiosk both communicating with the intermediate server. This method includes using separate network ports to convey wagering session data from the book's server that provides online wagering to an interactive kiosk and conveying responses from the interactive kiosk. Using a supper port, logging user-triggered events during the wagering session to an intermediate server in a second format with a distinctive end-of-stream marker, concurrently with the conveying responses. If further may include parsing screen sent by the book's server to the interactive kiosk, verifying that the screen substantially match a block message format or match registered screen templates previously provided by the book's server, and representing the screens for logging in a format with the distinctive industry marker. This variation further includes logging the wagering session with the intermediate server in real-time, as the wagering session proceeds, with sufficient detail to permit replay of the wagering session. Practicing this method may usefully employ a modified browser program to receive and display the screen sent by the book's server and transmit at least one user-triggered event concurrently to the book's server in a first format responsive to the screens and to the intermediate server in a second format and adapted to the logging of the wagering session. The method may be practiced as a computer implemented kiosk, including memory, a network connection, a processor coupled to the memory of a network connection, and logic and resources coupled to the processor and adapted to carry out the method and various aspects of the method described above.

A related embodiment is a method of channeling communications during a gaming session, including using separate ports to convey gaming artwork for a gaming session from a gaming server that provides downloadable games of skill or chance to an interactive kiosk and conveying responses from the kiosk. Using a separate, second network port, conveying gameplay tokens between the gaming server in the interactive kiosk, the gameplay tokens triggering a program running on the interactive kiosk that selects and displays the game artwork response of the gameplay tokens. This method further may include logging a gaming session in real-time on media secure against tampering from the interactive kiosk, as the gaming session proceeds, and with sufficient detail to permit replay of the gaming session. A third further network port may be used to download a game of skill or chance for the gaming session, whereby the gaming session begins with an up-to-date version of the game and not a cached version of the game. For gaming, all chance events may be determined using a random number generator dedicated to the gaming session and operating on a server coupled the interactive kiosk via the second network port. Optionally, the method may further include delaying delivery of the gameplay tokens that reveal any outcome of the gameplay until the interactive kiosk and any related interactive kiosk involved in the gameplay session have delivered to the gaming server gameplay tokens that define gamers bets and gameplay actions. The method may be practiced as a computer implemented kiosk, including memory, a network connection, a processor coupled to the memory of a network connection, and logic and resources coupled to the processor and adapted to carry out the method and various aspects of the method described above.

A further embodiment is a method of securing up adding a gaming system to satisfy regulatory authorities. This method includes attaching a multiplicity of interactive kiosks and at least one gaming server to a closed loop network, the closed loop network providing miles of connectivity paths and transporting gambling communication packets from the interactive kiosks to the gambling server without the gambling communication packets crossing state political boundaries. It optionally includes addressing the gambling communication packets using addresses that are recognized by devices in the closed loop network as internally forwardable within the closed loop network and not externally routable outside the closed loop network. One aspect of this method may be sharing the closed loop network with public subscribers, externally routable communication packets and non-gambling packets. Optionally, care may be taken to avoid marking the gambling communication packets in a way that would allow communication channel monitors to identify the gambling communication packets as gambling-related, other than by their addresses.

Another embodiment is a method of providing easy physical security control over remote administration packets bound for a gaming or betting server. This method includes interposing a first firewall between all traffic destined for a gambling server, the first firewall configured to route remote administration packets to a second firewall and route other packets elsewhere, and disabling transmission of the remote administration packets through the second firewall to the gambling server by a physical action, when remote administration packets are not supposed reach the gambling server. A further aspect of this embodiment is disabling transmission of the remote administration packets by powering down the second firewall or, alternatively, by physically interrupting a communication channel to or from the second firewall. Remote administration packets may be packets to reconfigure operation of the gambling server, impact odds of winning, spreads or payoffs of the gambling server or cause replay of the gambling session conducted by or through the gambling server.

Yet another embodiment is a method of delivering ads to an interactive kiosk. This method includes allocating an area of a touched-sensitive display on the interactive kiosk to language-based interaction with user. It includes, from an application program running a layer above operating system routines, mapping a first keyboard layout and language character sent to the touch-sensitive display, in support of a first language. Includes, from an application program running in a layer above the operating system routines, mapping a second keyboard layout and language character set to the touch sensitive display, in support of a second language, the second keyboard layout having different key locations and different usage of keys for characters than the first keyboard layout and the second language character set having different characters or additional characters than the first language character set. This method further includes displaying the first or second keyboard layout and language character set to the user, corresponding to whether the user prefers the first or second language. The method may be practiced on a computer implemented kiosk, including memory, a network connection, a processor coupled to the memory of a network connection, and logic and resources coupled to the processor and adapted to carry out the method and various aspects of the method described above.

While the present invention is disclosed by reference to the preferred embodiments and examples detailed above, it is understood that these examples are intended in an illustrative rather than in a limiting sense. Computer-assisted processing is implicated in the described embodiments. Accordingly, the present invention may be embodied in methods related to interactive kiosk, including utility and gambling kiosks, systems including logic and resources to carry out kiosk activities, systems that use computer-implemented interactive kiosks, media impressed with logic to carry out kiosk activities, data streams impressed with logic to carry out activities, or computer-accessible services that carry out computer-assisted activities. It is contemplated that modifications and combinations will readily occur to those skilled in the art, which modifications and combinations will be within the spirit of the invention and the scope of the following claims.

Appendix

SQL queries that may be useful with this invention are referenced below:

usp insertZKeyBoardMap: Developed application that allows definition of a keyboard and storing in database.

usp_addkeyboard: The keyboard is a reference number for the map.

usp_addschanged: Sets a flag in the database once advertising update has been confirmed by the kiosk.

usp_availablekeyboards: List of available languages and ids of keyboard maps.

usp_CCSetToProcessed: CC means credit card. Flags the CC information in the database as “processed” after the CC processing vendor has processed it. Processor has returned an approval or denial.

usp_createaccount: Stored procedure including subprocedures for user name, password, e-mail address, etc.

usp_createaccount_short: Skip home address and birth date when creating an account.

usp_CreateEmailAccount: Creates a pointer to an e-mail account that is dynamically created using iMail when they sign up for a new account.

usp_EndSession: Ends session. Writes updated time from kiosk to keep account of user's time usage.

usp_EndSessionTime: System called, e.g., after 2 minutes to time out the kiosk.

usp_GetAdminMachines: Associates an administrator user id with particular machines.

usp_GetAdminRights: Shows administrator rights for a particular machine.

usp_GetAds: 4:10, returns set of ads and pointers to download ads directly from the media server.

usp_GetCCStatus: Inquiry about status and results of processing a credit card transaction.

usp_GetMachineConfig: Global parms for system initialization. Size, layout, ad placement, etc.

usp_GetOwnerMachines: Owner and administrator may not be concentric.

usp_GetSessionActivity: Returns a complete session log for a unique user id.

usp_GetTransactions: A transaction involves money, in transferred, etc.

usp_getuser: Returns user name, user id, potentially a cleartext password. ODIE system uses cleartext instead of a has because the wager system requires a second login.

USP_insert_CCQueue: If any CC transactions are not yet marked processed, the CC transactions are

usp_insert_glenn_test dbo.

usp_insertError: A running list of errors is kept by the kiosk. It is cached and either transmitted or stored to a temporary file, if it has not been communicated when the system shuts down.

usp_Keyboard: Keyboard is the top level definition of the keyboard style

usp_KeyboardMap: Physical mapping of x-y coordinates and characters.

usp_KeyBoardTypes: US, Spanish, numerical, upper/lower, CAPS,

usp_LogActivity: Single record added to log.

usp_LogCallForHelp: Call for help registered and initiated as VOIP call.

usp_LogNonUserActivity: Ads can be clicked through without logging into the system.

usp_LogTransaction: Log of any monetary action. Allows tally of money made by or stored in machine.

usp_NextKeyBoardMapID: Holds in cache the next keyboard number, for instance to switch to Spanish from English.

usp_passwordexists: If password is being updated, but same one is being entered a second time, rejects the meaningless update.

usp_programglobals: Insert or update the program globals for a kiosk. Provides a web interface for updating globals.

usp_RegisterIPAddress: Associates an IP address with a machine ID.

usp_RenameDB.

usp_SetMailAcctProc: When a new mail account is created, a folder is created and a flag set to show that the mail account is usable.

usp_startSession: Creates a new unique session number and opens it.

usp_UdateNav: Updates navigation of internal flash files for display [??]

usp_UdateNav_web: Update is processed from web instead of entry at the kiosk.

usp_UnprocessedMailAcct: After an error, the flag from SetMailAcctProc is reversed.

usp_updateadclick: When in advertising system, this updates the link or movie that is started on a click-through.

usp_updateCCQueue: When credit card transaction request is entered by the user, it is queued into the database for processing.

usp_UpdateCredits: Minutes are stored as an account balance. Hour, minutes and seconds are the units of remaining time.

usp_UpdatePropGlobs: Standard master globals such as location and IP of SQL database used to configure.

usp_updateUserInfo: user name, e-mail address etc. updated

usp_updateZKeyBoardMap:

usp_UpdateZMachineSet: Update parameters of machine, such as location, name, physical address of machine.

XML support for bill payment is described below:

### Bulk Payments Services

These services provide interfaces into processing large volumes of payments from a diverse source of Payors and payees. The services expose creating and managing payments that are originated and settled either by electronic means, using the Remittance Payment and Processing System (RPPS) or by bank draft (Draft).

When processing payments, the caller can indicate the method of settlement by which service is used to create the payment. Merchant lists are maintained for electronic settlement as the merchant relationships have been previously defined. Use the appropriate Biller list service to determine the required BillerID. Also notice that when creating a payment with RPPS, the required Account Number must match a predefined mask. Use the GetRPPSBillerMaskList service to determine the allowable account number formats. The payment will reject if the account number does not match an available mask.

Merchant lists are not maintained for Draft payments. All the necessary information to process a Draft payment s provided during the creation of the draft, including the Payor and Payee address information.

The optional “PayDate” parameter in the Create services can be used to schedule a payment for future processing. Please note that the PayDate is the date in which the payment is processed. For RPPS payments this date will be the one business day before the Biller will receive the credit. For Draft payments, this date will be the day in which the bank draft is produced and forwarded to the Biller. The date the Biller receives the payment will be determined by the postal system timing, as well as the internal processed for posting bank drafts within the Biller environment.

The approval process for the “Bulk Payments” services is slightly different than other services, in that the payments are created in the “Approved” state and need only be “Released to be processed. Since the transaction can not be stopped or deleted once “Released”, care must be taken to ensure a payment is correct before “Releasing” the transaction. For this reason, as well as security reasons, it is recommended that a separate operational process be used to “Release” payments. Each Bulk Payments credentials can be given authority to “Create”, “Release” and “Delete” as well as any combination of the three.

If a payment is incorrect, use the appropriate Delete service to remove the transaction and create a new corrected transaction.

CreateDraftPayment

Creates a Draft payment transaction.

Request Parameters
PayorName Name of Payor (String—maximum 50 characters).
PayorAddress1 Optional. Address Line 1 of Payor (String—maximum 50 characters).
PayorAddress2 Optional. Address Line 2 of Payor (String—maximum 50 characters).
PayorCity Optional. City of Payor (String—maximum 30 characters).
PayorState Optional. State of Payor (String—maximum 2 characters).
PayorZip Optional. Zip Code of Payor (String—maximum 10 characters).
PayorAccountNumber Account Number or designator the Biller should use to credit this payment to. (String).
Amount Transaction amount in dollars (Currency).
PayeeName Name of Payee (String—maximum 50 characters).
PayeeAddress1 Address Line 1 of Payee (String—maximum 50 characters).
PayeeAddress2 Optional. Address Line 2 of Payee (String—maximum 50 characters).
PayeeCity City of Payee (String—maximum 30 characters).
PayeeState State of Payee (String—maximum 2 characters).
PayeeZip Zip Code of Payee (String—maximum 10 characters).
PayeeCountry Optional. Country code of Payee (String—maximum 3 characters). If omitted, “USA” is assumed.
Memo Optional. Transaction memo (String—maximum 50 characters). If provided this information will be printed on the bank draft.
PayDate Optional. Day to issue payment (Date). If omitted, the current date is assumed.

Sample Request
<Service ID=“1000”>
<Type>Bulk Payments</Type>
<Name>CreateDraftPayment</Name>
<PayorName>John Smith</PayorName>
<PayorAddress1>123 Main Street</PayorAddress1>
<PayorCity>Anytown</PayorCity>
<PayorState>CA</PayorState>
<PayorZip>12345</PayorZip>
<PayorAccountNumber>123-456</PayorAccountNumber>
<Amount>500.00</Amount>
<PayeeName>ABC Automotive</PayeeName>
<PayeeAddress1>38 South First Street</PayeeAddress1>
<PayeeAddress2>Suite 100</PayeeAddress2>
<PayeeCity>Anytown</PayeeCity>
<PayeeState>CA</PayeeState>
<PayeeZip>12345</PayeeZip>
<Memo>Repair of vehicle</Memo>
</Service>

Response Parameters

DraftPaymentID ID used to reference this Draft payment (Integer).

Sample Response
<Results Count=“1”>
<ResultsItem ID=“1”>
<DraftPaymentID>1021</DraftPaymentID>
</ResultsItem>
</Results>

CreateRPPSPayment

Creates an RPPS payment transaction.

Request Parameters
RPPSBillerID Unique identifier of the requested Biller. (String—10 characters). Use the GetRPPSBillerList service to lookup this ID.
BillerAccountNumber Account Number the Biller should use to credit this payment to. (String). This parameter must match an existing mask associated with this biller. Use the GetRPPSBillerMaksList to retrieve a list of masks used for a specific biller.
PayorName Name of Payor (String—maximum 50 characters).
AmountTransaction amount in dollars (Currency).
PayDate Optional. Day to issue payment (Date). If omitted, the current date is assumed.

Sample Request
<Service ID=“1000”>
<Type>Bulk Payments</Type>
<Name>CreateRPPSPayment</Name>
<RPPSBillerID>0000000012</RPPSBillerID>
<BillerAccountNumber>5824628671</BillerAccountNumber>
<PayorName>John Smith</PayorName>
<Amount>127.00</Amount>
</Service>

Response Parameters

RPPSPaymentID ID used to reference this RPPS payment (Integer).

Sample Response
<Results Count=“1”>
<ResultsItem ID=“1”>
<RPPSPaymentID>36943</RPPSPaymentID>
</ResultsItem>
</Results>

DeleteDraftPayment

Deletes a Draft payment transaction.

Request Parameters

DraftPaymentID Unique. ID of Draft payment (Integer).

Sample Request
<Service ID=“1000”>
<Type>Bulk Payments</Type>
<Name>DeleteDraftPayment</Name>
<DraftPaymentID>1021</DraftPaymentID>
</Service>

Response Parameters

(none) No response parameters, only status.

Sample Response

<Results Count=“0”/>

DeleteRPPSPayment

Deletes a RPPS payment transaction.

Request Parameters

RPPSPaymentID Unique ID of RPPS payment (Integer).

Sample Request
<Service ID=“1000”>
<Type>Bulk Payments</Type>
<Name>DeleteRPPSPayment</Name>
<RPPSPaymentID>36943</RPPSPaymentID>
</Service>

Response Parameters

(none) No response parameters, only status.

Sample Response

<Results Count=“0”/>

GetDraftPaymentList

Returns a list of Draft payment transactions using the provided search criteria.

Request Parameters
DraftPaymentID Optional. Unique ID of Draft payment (Integer).
PayorAccountNumber Optional. Payor Account Number used when Draft Payment was created (String).
Status Optional. Single character status code to limit search (see appendix for table) (character).
PayDate Optional. Date the payment is/was to be processed (Date).

Sample Request
<Service ID=“1000”>
<Type>Bulk Payments</Type>
<Name>GetDraftPaymentList</Name>
<DraftPaymentID>1021</DraftPaymentID>
</Service>

Response Parameters
DraftPaymentID ID used to reference this Draft payment (Integer).
PayorName Name of Payor (String).
PayorAddress1 Address Line 1 of Payor (String).
PayorAddress2 Address Line 2 of Payor (String).
PayorCity City of Payor (String).
PayorState State of Payor (String).
PayorZip Zip Code of Payor (String).
PayorAccountNumber Payor Account Number (String).
Amount Transaction amount in dollars (Currency).
PayeeName Name of Payee (String).
PayeeAddress1 Address Line 1 of Payee (String).
PayeeAddress2 Address Line 2 of Payee (String).
PayeeCity City of Payee (String).
PayeeState State of Payee (String).
PayeeZip Zip Code of Payee (String).
PayeeCountry Country code of Payee (String).
Memo Transaction memo (String).
Status Single character status code indicating the current status of the identified transaction (see appendix for table) (character).
EntryDateTime Date and Time the transaction was created (DateTime).
PayDate Day to issue payment (Date).
ProcessedDateTime Date and Time the transaction was processed (DateTime).

Sample Response
<Results Count=“1”>
<ResultsItem ID=“1”>
<DraftPaymentID>1021</DraftPaymentID>
<PayorName>John Smith</PayorName>
<PayorAddress1>123 Main Street</PayorAddress1>
<PayorAddress2 />
<PayorCity>Anytown</PayorCity>
<PayorState>CA</PayorState>
<PayorZip>12345</PayorZip>
<PayorAccountNumber>123-456</PayorAccountNumber>
<Amount>500.00</Amount>
<PayeeName>ABC Automotive</PayeeName>
<PayeeAddress1>38 South First Street</PayeeAddress1>
<PayeeAddress2>Suite 100</PayeeAddress2>
<PayeeCity>Anytown</PayeeCity>
<PayeeState>CA</PayeeState>
<PayeeZip>12345</PayeeZip>
<PayeeCountry>USA</PayeeCountry>
<Memo>Repair of vehicle</Memo>
<Status>A</Status>
<EntryDateTime>Jun. 11, 2004 3:52:16 PM</EntryDateTime>
<PayDate>Jun. 11, 2004</PayDate>
<ProcessedDateTime />
</ResultsItem>
</Results>

GetRPPSBillerAddressList

Returns a list of Addresses for a specific RPPS Biller.

Request Parameters

RPPSBillerID Unique identifier of the requested Biller. (String—10 characters). Use the GetRPPSBillerList service to lookup this ID.

Sample Request
<Service ID=“1000”>
<Type>Bulk Payments</Type>
<Name>GetRPPSBillerAddressList</Name>
<RPPSBillerID>0000000012</RPPSBillerID>
</Service>

Response Parameters
Address1 Address Line 1 (String).
Address2 Address Line 2 (String).
City City (String).
State State (String).
Zip Zip Code (String).
Country Country Code (String).

Sample Response
<Results Count=“1”>
<ResultsItem ID=“1”>
<Address1>PO Box 52044</Address1>
<Address2 />
<City>Phoenix</City>
<State>AZ</State>
<Zip />
<Country>USA</Country>
</ResultsItem>
</Results>

GetRPPSBillerList

Returns a list of RPPS Billers using the provided search criteria.

Request Parameters
RPPSBillerID Optional. Unique identifier of the requested Biller. (String—10 characters).
BillerName Optional; Name of the Biller (String—maximum 50 chars.). Use “*” to indicate a wildcard at the beginning and/or end of the string to return Billers that contain the entered string. For example “First*” will return “First Energy” as well as “First Choice” while “*First*” will include “AllFirst Mtg” in the results.

Sample Request
<Service ID=“1000”>
<Type>Bulk Payments</Type>
<Name>GetRPPSBillerList</Name>
<RPPSBillerID>0000000012</RPPSBillerID>
</Service>

Response Parameters
RPPSBillerID Unique identifier of the Biller (String).
BillerName Name of the Biller (String).
BillerOldName Old Name of the Biller (String).
BillerClass Classification of the Biller (String).
BillerType Type of the Biller (String).
EffectiveDate Date the Biller began taking RPPS payments (Date).
BillerNote Note Biller has included in their profile (String). This note is used to provide additional or clarifying information that can be helpful in processing payments for the Biller. If a note is provided you should use the information accordingly.

Sample Response
<Results Count=“1”>
<ResultsItem ID=“1”>
<RPPSBillerID>0000000012</RPPSBillerID>
<BillerName>Jones Store</BillerName>
<BillerOldName />
<BillerClass>Retail</BillerClass>
<BillerType>Core</BillerType>
<EffectiveDate>Sep. 27, 1999</EffectiveDate>
<BillerNote />
</ResultsItem>
</Results>

GetRPPSBillerMaskList

Returns a list of Masks for a specific RPPS Biller. Use the masks to properly structure the BillerAccountNumber provided in the CreateRPPSPayment service.

Request Parameters

RPPSBillerID Unique identifier of the requested Biller. (String—10 characters). Use the GetRPPSBillerList service to lookup this ID.

Sample Request
<Service ID=“1000”>
<Type>Bulk Payments</Type>
<Name>GetRPPSBillerMaskList</Name>
<RPPSBillerID>0000000012</RPPSBillerID>
</Service>

Response Parameters
MaskLength Length of the Mask in characters (Integer).
Mask Mask (String). The mask is made up of characters indicating the allowable characters in each character position of the account number. A “#” indicates that any numeric character (0-9) is allowed. A “*” indicates that any capitalized alphabetic character (A-Z) is allowed. A “@” indicates that any numerica character (0-9) or any capitalized alphabetic character (A-Z) is allowed. Any other character indicates that the specified character is required to be in the defined position.

Sample Response
<Results Count=“1”>
<ResultsItem ID=“1”>
<MaskLength>10</MaskLength>
<Mask>##########</Mask>
</ResultsItem>
</Results>

GetRPPSPaymentList

Returns a list of RPPS payment transactions using the provided search criteria.

Request Parameters
RPPSPaymentID Optional. Unique ID of RPPS payment (Integer).
RPPSBillerID Optional. Unique identifier of the requested Biller. (String—10 characters). Use the GetRPPSBillerList service to lookup this ID. BillerAccountNumber Optional. Biller Account Number used when RPPS Payment was created (String).
Status Optional. Single character status code to limit search (see appendix for table) (character).
PayDate Optional. Date the payment is/was to be processed (Date).

Sample Request
<Service ID=“1000”>
<Type>Bulk Payments</Type>
<Name>GetRPPSPaymentList</Name>
<RPPSBillerID>0000000012</RPPSBillerID>
</Service>

Response Parameters
RPPSPaymentID ID used to reference this RPPS payment (Integer).
RPPSBillerID Unique identifier of the Biller (String).
BillerAccountNumber Biller Account Number (String).
PayorName Name of Payor (String).
AmountTransaction amount in dollars (Currency).
Status Single character status code inidicating the current status of the identified transaction (see appendix for table) (character).
EntryDateTime Date and Time the transaction was created (DateTime).
PayDate Day to issue payment (Date).
ProcessedDateTime Date and Time the transaction was processed (DateTime).

Sample Response
<Results Count=“1”>
<ResultsItem ID=“1”>
<RPPSPaymentID>36943</RPPSPaymentID>
<RPPSBillerID>0000000012</RPPSBillerID>
<BillerAccountNumber>5824628671</BillerAccountNumber
<PayorName>John Smith</PayorName>
<Amount>127.00</Amount>
<Status>A</Status>
<EntryDateTime>Jun. 11, 2004 4:07:42 PM</EntryDateTime>
<PayDate>Jun. 11, 2004</PayDate>
<ProcessedDateTime />
</ResultsItem>
</Results>

ReleaseDraftPayment

Releases a Draft payment transaction for processing.

Request Parameters

DraftPaymentID Unique ID of Draft payment (Integer).

Sample Request
<Service ID=“1000”>
<Type>Bulk Payments</Type>
<Name>ReleaseDraftPayment</Name>
<DraftPaymentID>1021</DraftPaymentID>
</Service>

Response Parameters

(none) No response parameters, only status.

Sample Response

<Results Count=“0”/>

ReleaseRPPSPayment

Releases a RPPS payment transaction for processing.

Request Parameters

RPPSPaymentID Unique ID of RPPS payment (Integer).

Sample Request
<Service ID=“1000”>
<Type>Bulk Payments</Type>
<Name>ReleaseRPPSPayment</Name>
<RPPSPaymentID>36943</RPPSPaymentID>
</Service>
Response Parameters
(none) No response parameters, only status.

Sample Response

<Results Count=“0”/>

We claim as follows:

1. A method of providing on-line kiosk services, the method including:
executing a boot code on a computerized interactive kiosk attached to a network, the boot code opening a network port to a remote database and making a query to retrieve configuration data;
receiving from the remote database the configuration data and applying the configuration data to configure at least
partitioning of a kiosk screen into at least advertising, interactive display and status areas,
at least one input device coupled to the kiosk, and
one or more server addresses from which the kiosk obtains at least advertising media, programs that interact with a user and programs that control the input device;
opening at least one additional network port to download advertising media and to provide interactive services.

2. The method of claim 1, further including making the query as an SQL database query using a kiosk ID to identify the configuration data to be retrieved.

3. The method of claim 1, further including applying the configuration data to configure screen dimensions of the kiosk screen.

4. The method of claim 1, further including applying the configuration data to configure as an input device a touch screen.

5. The method of claim 4, further including applying the configuration data to configure as an input device a currency reader.

6. The method of claim 4, further including applying the configuration data to configure as an input device a card reader.

7. The method of claim 4, further including applying the configuration data to configure as an input device a check encoding reader.

8. The method of claim 4, further including applying the configuration data to configure as an input device a bar code scanner.

9. The method of claim 4, further including applying the configuration data to configure as an input/output device a voice over IP telephone.

10. A computer-implemented kiosk, including:
memory;
a network connection;
a processor coupled to the memory and the network connection;
logic and resources coupled with the processor and adapted to carry out the method of claim 1.

11. A computer-implemented kiosk, including:
memory;
a network connection;
a processor coupled to the memory and the network connection;
logic and resources coupled with the processor and adapted to carry out the method of claim 9.

12. The method of claim 1, further including:
applying the configuration data to enable communications with at least one book's server that provides on-line wagering;
opening two or more further network ports to
communicate wagers between the interactive kiosk and the book's server, and
log with an intermediate server gamer inputs and terminal displays during wagering sessions;
logging the wagering session with the intermediate server in real time, as the wagering session is conducted, and with sufficient detail to permit replay of the wagering session.

13. The method of claim 12, further including transporting communication packets between the interactive kiosk and the book's server on a closed loop network without transporting the communications packets across state political borders.

14. The method of claim 13, further including assigning the communication packets IP addresses that are understood by routing devices to be internally forwardable within the closed loop network and not externally routable outside the closed loop network.

15. The method of claim 12, further including parsing screens sent by the book's server to the interactive kiosk, verifying that the screens substantially match registered screens previously provided by the book's server and representing the screens and user responses to the screens for logging in a format with a distinctive end-of-stream marker.

16. A computer-implemented kiosk, including:
memory;
a network connection;
a processor coupled to the memory and the network connection;
logic and resources coupled with the processor and adapted to carry out the method of claim 12.

17. A computer-implemented kiosk, including:
memory;
a network connection;
a processor coupled to the memory and the network connection;
logic and resources coupled with the processor and adapted to carry out the method of claim 15.

18. The method of claim 1, further including:
applying the configuration data to enable communications with at least a game of chance server that provides at least one downloadable game play program;
opening two or more further network ports to
communicate artwork from the game of chance server to the interactive kiosk, and communicate game play tokens;
logging the game play sessions with an intermediate server in real time, as game play proceeds, and with sufficient detail to permit replay of the game play session; and
displaying the artwork on the interactive kiosk consistent with the game play tokens.

19. The method of claim 18, further including generating game play tokens with a game play server having a random number generator that is dedicated to the interactive kiosk and any related interactive kiosks receiving the game play tokens for a same session of the game of chance.

20. The method of claim 19, further including delaying delivery of the game play tokens that reveal any outcome of the game play until the interactive kiosks have delivered to the game play server game play tokens that define gamers' bets and game play actions.

21. The method of claim 18, further including transporting communication packets between the interactive kiosk and the game play server on a closed loop network without transporting the communications packets across state political borders.

22. A computer-implemented kiosk, including:
memory;
a network connection;
a processor coupled to the memory and the network connection;
logic and resources coupled with the processor and adapted to carry out the method of claim 18.

23. A computer-implemented kiosk, including:
memory;
a network connection;
a processor coupled to the memory and the network connection;
logic and resources coupled with the processor and adapted to carry out the method of claim 21.

24. The method of claim 1, further including:
applying the configuration data to enable communications with at least a game of skill server that provides at least one downloadable game play program;
opening two or more further network ports to
communicate artwork from the game of skill server to the interactive kiosk, and
communicate game play tokens;
logging the game play session with an intermediate server in real time, as game play proceeds, and with sufficient detail to permit replay of the game play session; and
displaying the artwork on the interactive kiosk consistent with the game play tokens.

25. The method of claim 24, further including generating game play tokens with a game play server having a random number generator that is dedicated to the interactive kiosk and any related interactive kiosks receiving the game play tokens for a same session of the game of skill.

26. The method of claim 25, further including delaying delivery of the game play tokens that reveal any outcome of the game play until the interactive kiosks have delivered to the game play server game play tokens that define gamers' bets and game play actions.

27. The method of claim 24, further including transporting communication packets between the interactive kiosk and the game play server on a closed loop network without transporting the communications packets across state political borders.

28. A computer-implemented kiosk, including:
memory;
a network connection;
a processor coupled to the memory and the network connection;
logic and resources coupled with the processor and adapted to carry out the method of claim 24.

29. A computer-implemented kiosk, including:
memory;
a network connection;
a processor coupled to the memory and the network connection;
logic and resources coupled with the processor and adapted to carry out the method of claim 27.

30. A method of channeling communications related to a wagering session involving at least a book's server, an intermediate server, and an interactive kiosk, the book's server and the interactive kiosk both communicating with the intermediate server, the method including:
using separate network ports,
conveying wagering session data from a book's server that provides on-line wagering to an interactive kiosk and conveying responses, and
logging user-triggered events during the wagering session to an intermediate server in a second format with a distinctive end-of-stream marker, concurrently with the conveying responses.

31. The method of claim 30, further including:
parsing screens sent by the book's server to the interactive kiosk, verifying that the screens substantially match registered screen templates previously provided by the book's server and representing the screens for logging in a format with a distinctive end-of-stream marker; and
logging the wagering session with the intermediate server in real time, as the wagering session proceeds, and with sufficient detail to permit replay of the wagering session.

32. The method of claim 31, further including using a modified browser program to
receive and display the screens sent by the book's server, and
transmit at least one user-triggered event concurrently to the book's server in a first format responsive to the screens and to the intermediate server in a second format adapted to the logging of the wagering session.

33. A method of channeling communications during to a gaming session, the method including:
using separate network ports,
a first network port conveying game artwork for a gaming session from a gaming server that provides downloadable games of skill or chance to an interactive kiosk and conveying responses, and
a second network port conveying game play tokens between the gaming server and the interactive kiosk, the game play tokens from the gaming server triggering a program running on the interactive kiosk that selects and displays the game artwork responsive to the game play tokens;
logging the gaming session in real time on media secure against tampering from the interactive kiosk, as the gaming session proceeds, and with sufficient detail to permit replay of the gaming session.

34. The method of claim 33, further including using a third network port to download a game of skill or chance for the gaming session, whereby the gaming session begins with an up-to-date version of the game and not a cached version of the game.

35. The method of claim 33, further including determining all chance events using a random number generator dedicated to the gaming session and operating on a server coupled to the interactive kiosk via the second network port.

36. The method of claim 33, further including delaying delivery of the game play tokens that reveal any outcome of the game play until the interactive kiosk and any related interactive kiosks involved in the game play session have delivered to the gaming server game play tokens that define gamers' bets and game play actions.

37. A method of securing a betting or gaming system to satisfy regulatory authorities, including:
attaching a multiplicity of interactive kiosks and at least one gambling server to a closed loop network, the closed loop network providing miles of connectivity paths and transporting gambling communication packets from the interactive kiosks to the gambling server without the gambling communication packets crossing state political boundaries; and
addressing the gambling communication packets using addresses that are recognized by devices in the closed loop network as internally routable within the closed loop network and not externally routable outside the closed loop network.

38. The method of claim 37, further including carrying public subscriber, externally routable and non-gambling packets on the closed loop network, and avoiding marking of the gambling communication packets in a way that would allow communication channel monitors to identify the gambling communication packets as gambling-related, other than by their address.

39. A method of providing easy physical security control over remote administration packets bound for a gaming or betting server, the method including:
interposing a first firewall between all traffic destined for a gambling server, the first firewall configured to route remote administration packets to a second firewall and route other packets elsewhere; and
disabling transmission of the remote administration packets through the second firewall to the gambling server by a physical action, when remote administration packets are not supposed to reach the gambling server.

40. The method of claim 39, further including disabling transmission of the remote administration packets through the second firewall by powering down the second firewall.

41. The method of claim 39, further including disabling transmission of the remote administration packets through the second firewall by physically interrupting a communication channel with the second firewall.

42. The method of claim 39, wherein remote administration packets reconfigure operation of the gambling server.

43. The method of claim 39, wherein remote administration packets impact odds of winning, spreads or payoffs of the gambling server.

44. The method of claim 39, wherein remote administration packets impact cause replay of a gambling session conducted by or through the gambling server.

45. A method of delivering ads to an interactive kiosk, including:
assigning a kiosk ID that is unique and indicates the state, city and area within the city in which the interactive kiosk is located; and
displaying ads on the interactive kiosk during a session with a weighted preference for ads targeted to the area over ads targeted to the city over ads targeted to the state in which the interactive kiosk is located.

46. A method of adapting an interactive kiosk to a language preferred by a user, including:
allocating an area of a touch-sensitive display on the interactive kiosk to language-based interaction with the user;
from an application program running at a layer above operating system routines, mapping a first keyboard layout and language character set to the touch-sensitive display, in support of a first language;
from an application program running at a layer above operating system routines, mapping a second keyboard layout and language character set to the touch-sensitive display, in support of a second language, the second keyboard layout having different key locations and different usage of keys for characters than the first keyboard layout and the second language character set having different characters or additional characters than the first language character set; and
displaying the first or second keyboard layout and language character set to the user, corresponding to whether the user prefers the first or second language.
